(19) United States
(12) Patent Application Publication
(10) Pub. No.: US 2022/0371512 A1
(43) Pub. Date: Nov. 24, 2022

(54) INFORMATION PROCESSING DEVICE AND METHOD, AND PROGRAM

(71) Applicant: SONY GROUP CORPORATION, TOKYO (JP)

(72) Inventors: SHIGEKI TATEMATSU, TOKYO (JP); MICHIRO HIRAI, TOKYO (JP)

(21) Appl. No.: 17/754,611

(22) PCT Filed: Oct. 2, 2020
(86) PCT No.: PCT/JP2020/037529

§ 371 Date: Apr. 7, 2022

(30) Foreign Application Priority Data
Oct. 16, 2019 (JP) 2019-189082

(51) Int. Cl. B60Q 9/00; G06V 30/19; G06V 20/62; G06V 20/52; G08G 1/017; G05D 1/02

(52) U.S. Cl. CPC B60Q 9/00; G06V 30/19; G06V 20/625; G06V 20/52; G08G 1/0175; G05D 1/021

(57) ABSTRACT

The present disclosure relates to an information processing device and method, and a program that enable processing corresponding to a recognition result with respect to a license plate of a vehicle.

On the basis of a recognition result with respect to a license plate of a vehicle in a captured image, characteristic information of the vehicle is extracted from the captured image, and processing corresponding to the extracted characteristic information of the vehicle is performed. The present disclosure can be applied to, for example, an information processing device, an image processing device, a communication device, an electronic apparatus, an information processing method, a program, or the like.

### TECHNICAL FIELD

The present disclosure relates to an information processing device and method, and a program, and more particularly to an information processing device and method, and a program that enable processing corresponding to a recognition result with respect to a license plate of a vehicle.

### BACKGROUND ART

In recent years, there has been considered a method for recognizing a vehicle registration number written on a license plate attached to a vehicle, from a captured image of the vehicle (refer to Patent Document 1, for example). Furthermore, there has been considered a method for recognizing the vehicle registration number, and managing entering and exiting of the vehicle by using the recognized vehicle registration number, in a parking area or the like (refer to Patent Document 2, for example).

### CITATION LIST

### Patent Document

Patent Document 1: Japanese Patent No. 4973341
Patent Document 2: Japanese Patent Application Laid-Open No. 2008-176472

### SUMMARY OF THE INVENTION

### Problems to be Solved by the Invention

However, Patent Document 1 and Patent Document 2 only describe a case where a vehicle registration number written on a license plate is recognized in which subsequent processing is performed by using the vehicle registration number, and do not disclose processing corresponding to a case where a vehicle registration number cannot be recognized. Therefore, it has been required to perform more appropriate processing for a recognition result with respect to a license plate of a vehicle.

The present disclosure has been made in view of such circumstances, and an object thereof is to perform processing more appropriate to a recognition result with respect to a license plate of a vehicle.

### Solutions to Problems

An information processing device according to one aspect of the present technology is an information processing device including a characteristic extraction unit that extracts, from a captured image, on the basis of a recognition result with respect to a license plate of a vehicle in the captured image, characteristic information of the vehicle, and a processing execution unit that performs processing corresponding to the characteristic information of the vehicle, the characteristic information being extracted by the characteristic extraction unit.

An information processing method according to one aspect of the present technology is an information processing method including extracting, from a captured image, on the basis of a recognition result with respect to a license plate of a vehicle in the captured image, characteristic information of the vehicle, and performing processing corresponding to the extracted characteristic information of the vehicle.

A program according to one aspect of the present technology is a program that causes a computer to function as a characteristic extraction unit that extracts, from a captured image, on the basis of a recognition result with respect to a license plate of a vehicle in the captured image, characteristic information of the vehicle, and a processing execution unit that performs processing corresponding to the characteristic information of the vehicle, the characteristic information being extracted by the characteristic extraction unit.

In the information processing device and method, and program according to one aspect of the present technology, characteristic information of the vehicle is extracted from a captured image on the basis of a recognition result with respect to a license plate of a vehicle in the captured image, and processing corresponding to the extracted characteristic information of the vehicle is performed.

### BRIEF DESCRIPTION OF DRAWINGS

FIG. 1 is a diagram illustrating a main configuration example of a passage control system.

FIG. 2 is a block diagram illustrating a main configuration example of an imaging device.

FIG. 3 is a block diagram illustrating a main configuration example of a control device.

FIG. 4 is a diagram describing an overview of plate detection and character recognition.

FIG. 5 is a diagram describing examples of license plates.

FIG. 6 is a diagram describing examples of causes of failure in character recognition.

FIG. 7 is a diagram illustrating a main configuration example of registration information in a registered vehicle database.

FIG. 8 is a block diagram illustrating a main configuration example of a gate device.

FIG. 9 is a flowchart describing an example of a flow of passage control processing.

FIG. 10 is a flowchart describing an example of a flow of image analysis processing.

FIG. 11 is a flowchart describing an example of a flow of control processing.

FIG. 12 is a block diagram illustrating a main configuration example of the control device.

FIG. 13 is a diagram illustrating a main configuration example of registration information in a passage management database.

FIG. 14 is a flowchart describing an example of a flow of control processing.

FIG. 15 is a diagram illustrating a main configuration example of the passage control system.

FIG. 16 is a diagram illustrating a main configuration example of a mechanical parking area control system.

FIG. 17 is a diagram illustrating a main configuration example of a guidance control system.

FIG. 18 is a diagram illustrating a main configuration example of a notification control system.

FIG. 19 is a block diagram illustrating a main configuration example of a computer.

### MODES FOR CARRYING OUT THE INVENTION

Modes for carrying out the present disclosure (hereinafter, referred to as embodiments) will be described below. Note that the description will be made in the following order.

1. First embodiment (passage control system)

2. Second embodiment (passage control system)

3. Third embodiment (other systems)

4. Supplementary note

### 1. First Embodiment

<Recognition of Characters in License Plate, and System Utilizing Result Thereof>

As described in Patent Document 1 for example, in recent years, there has been considered a method for recognizing a vehicle registration number written on a license plate attached to a vehicle, from a captured image of the vehicle. Furthermore, as described in Patent Document 2, there has been considered a method for recognizing the vehicle registration number in a parking area or the like, and managing entering and exiting of the vehicle by using the recognized vehicle registration number.

However, Patent Document 1 and Patent Document 2 only describe a case where a vehicle registration number written on a license plate can be recognized in which subsequent processing is performed by using the vehicle registration number. That is, these documents do not disclose processing corresponding to a case where a vehicle registration number cannot be recognized.

For example, in a case where a vehicle registration number on a license plate included in a captured image can be recognized, the system described in Patent Document 1 registers the recognized vehicle registration number to a database. Meanwhile, in a case where the vehicle registration number cannot be recognized, the system only deletes the captured image. That is, in this case, processing related to registration to a database is not performed.

Furthermore, a system described in Patent Document 2 reads a vehicle registration number on a license plate, and performs vehicle entering/exiting management by using the read vehicle registration number. For example, the system matches the read vehicle registration number with a vehicle registration number read at a time of vehicle entering, and performs processing such as payment processing or exit gate opening in a case where the matching is successful. Meanwhile, processing in a case where a vehicle registration number cannot be read is not described in Patent Document 2.

As described above, in these systems, in a case where a vehicle registration number cannot be recognized, “not to perform processing” is selected, and therefore processing suitable for such a case cannot be performed. For example, in a case of a method described in Patent Document 2, if a vehicle registration number cannot be recognized, an exit gate is never opened. Therefore, there has been a possibility of an increasing number of cases where the exit gate does not open unnecessarily, reducing convenience as a system.

Therefore, it has been required to perform more appropriate processing for a recognition result with respect to a license plate of a vehicle.

Therefore, characteristic information of a vehicle is extracted from a captured image on the basis of a recognition result with respect to a license plate of a vehicle in the captured image, and processing corresponding to the extracted characteristic information of the vehicle is performed.

For example, an information processing device includes a characteristic extraction unit that extracts, from a captured image, on the basis of a recognition result with respect to a license plate of a vehicle in the captured image, characteristic information of the vehicle, and a processing execution unit that performs processing corresponding to the characteristic information of the vehicle, the characteristic information being extracted by the characteristic extraction unit.

For example, with a program, a computer is caused to function as a characteristic extraction unit that extracts, from a captured image, on the basis of a recognition result with respect to a license plate of a vehicle in the captured image, characteristic information of the vehicle, and as a processing execution unit that performs processing corresponding to the characteristic information of the vehicle, the characteristic information being extracted by the characteristic extraction unit.

With this arrangement, it is possible to perform processing more appropriate to a recognition result with respect to a license plate of a vehicle in a captured image. Therefore, it is possible to perform processing more appropriate to a situation. For example, even in a case where a vehicle registration number on a license plate cannot be recognized, processing corresponding to the case can be performed.

<Passage Control System>

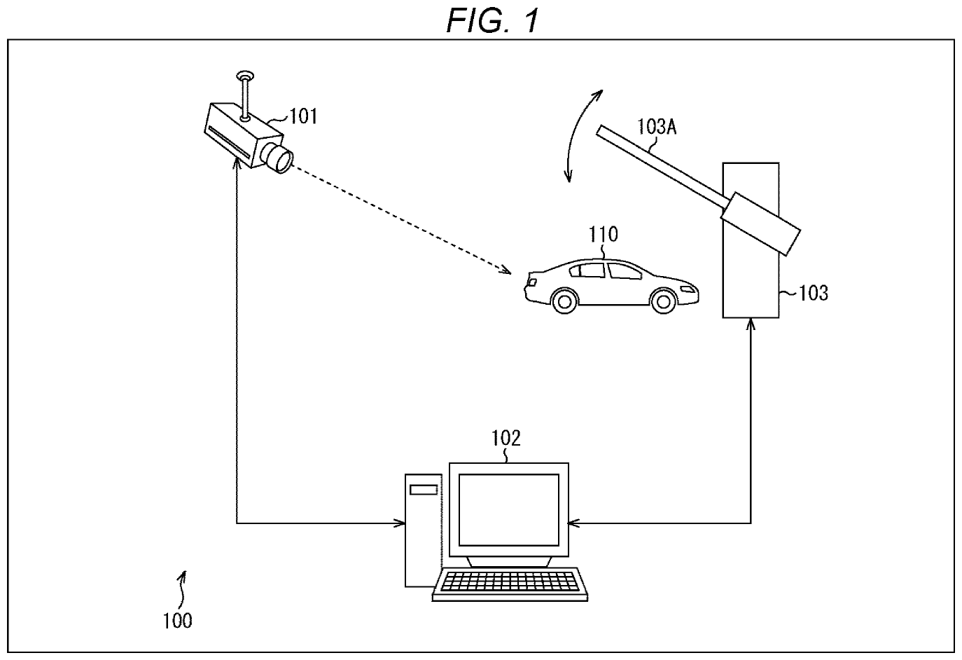

FIG. 1 is a block diagram illustrating an example of a main configuration of a passage control system that is one aspect of an information processing system to which the present technology is applied. A passage control system 100 illustrated in FIG. 1 is a system that controls passage of a vehicle by opening and closing a gate. As illustrated in FIG. 1, the passage control system 100 includes an imaging device 101, a control device 102, and a gate device 103.

An automobile 110 is a vehicle of which passage is controlled by the gate device 103 (the passage control system 100). A license plate is installed at a predetermined position (for example, front and rear) of a vehicle body of the automobile 110.

Note that, although the automobile 110 is illustrated in FIG. 1 as an example of a target of which passage is controlled, the target of which passage is controlled by the passage control system 100 is not limited thereto, and may be any vehicle as long as a license plate is installed thereon.

Furthermore, in the present description, a license plate is a plate for indicating an identification number or the like for managing a vehicle registered in a national government, a local government, or the like. The license plate includes, for example, a vehicle registration plate for displaying an automobile registration number, a vehicle number plate or license plate for displaying a vehicle number, and the like in Japan. Furthermore, the license plate includes a license plate in the United States of America and the like.

Note that, in practice, not only a number but also a character, a symbol, or the like is written on the license plate. Hereinafter, unless otherwise identified, a number, a character, a symbol, and the like written on a license plate will be described as a “character” without being distinguished from one another. Furthermore, a “character string (which may include a character, a number, or a symbol)”, which is an automobile registration number, a vehicle number, or the like, written on a license plate is also referred to as a “vehicle registration number”.

Similarly to a so-called monitoring camera, the imaging device 101 is installed near the gate device 103 and captures an image of the automobile 110 passing in a vicinity of the gate device 103. An installation place of the imaging device 101 is arbitrary. For example, the imaging device 101 may be installed at a position where the imaging device 101 can capture an image of a license plate installed on a rear of the automobile 110. Alternatively, the imaging device 101 may be installed at a position where the imaging device 101 can capture an image of a license plate installed on a front of the automobile 110.

The imaging device 101 captures an image of the automobile 110 and generates the captured image. The imaging device 101 and the control device 102 are communicably connected by wired communication or wireless communication. The imaging device 101 supplies the generated captured image to the control device 102. Note that the captured image may be a single or a plurality of still images or moving images.

For example, the imaging device 101 may continuously capture an image of a region where the gate device 103 controls passage of the automobile 110, and may transmit, to the control device 102, a captured still image or moving image in which the automobile 110 is caught, if the automobile 110 that has entered an angle of view is detected from the captured image. Furthermore, a captured image (moving image) that the imaging device 101 continuously captures and generates may be transmitted to the control device 102, and, from the captured image, the control device 102 may detect the automobile 110 entering the angle of view.

Note that the imaging device 101 may have a variable focal length. For example, the imaging device 101 may have an autofocus function of automatically focusing on a subject, or may have a so-called zoom function. Furthermore, the imaging device 101 may be able to change an imaging orientation. For example, the imaging device 101 may have a panning/tilting function.

The control device 102 controls the gate device 103 on the basis of the captured image supplied from the imaging device 101. For example, the control device 102 performs image analysis on the captured image to perform detection of a license plate of the automobile 110, recognition of characters of a vehicle registration number or the like, extraction of a characteristic of the automobile 110, or the like. Then, on the basis of these image analysis results, the control device 102 decides processing to be performed by the gate device 103.

The control device 102 is communicably connected to the gate device 103 by wired communication or wireless communication. The control device 102 supplies control information to the gate device 103 to cause the gate device 103 to execute processing decided by control device 102.

Note that the control device 102 may be able to control imaging by the imaging device 101. For example, the control device 102 may designate an imaging direction or zoom magnification for the imaging device 101, or may designate a timing of capturing a still image (that is, an imaging timing). Furthermore, the control device 102 may instruct the imaging device 101 to perform re-imaging.

The gate device 103 includes an openable and closable gate 103A. The gate device 103 controls passage of the automobile 110 in a predetermined region, such as an entrance or exit of a parking area for example, by opening or closing the gate 103A under control of the control device 102. Note that, for example, a shutter may be used instead of the gate 103A. That is, the gate device 103 may control passage of the automobile 110 by opening and closing the shutter.

Furthermore, the gate device 103 may include a monitor (a display device) that displays an image, a speaker (an audio output device) that outputs audio, or the like, and may be able to perform notification (output of an image, audio, and the like) to an occupant of the automobile 110.

As described above, the passage control system 100 performs detection of a license plate of the automobile 110, recognition of characters of a vehicle registration number or the like written on the license plate, extraction of a characteristic of the automobile 110, or the like, and controls opening and closing of the gate and the like on the basis of results of the processing.

The passage control system 100 is installed at, for example, a parking area of a condominium, a parking area of a company, a parking area of a commercial facility such as a supermarket or a department store, a parking area of a hotel, or a tollgate of a toll road, or the like.

For example, in a case of a parking area of a condominium, vehicles allowed to be parked are limited to vehicles (the automobile 110, for example) owned by a resident of the condominium, a regular supplier, a guest invited by a resident, and the like. Information of these vehicles can be registered in advance. The imaging device 101 and the gate device 103 are installed at an entrance, exit, or the like of the parking area, and the control device 102 is installed in a management office within premises of the condominium, or the like. On the basis of captured images and information registered in advance, the passage control system 100 controls passage of vehicles so as to permit only entering and exiting of vehicles owned by a resident of the condominium, a regular supplier, a guest invited by a resident, and the like.

Furthermore, for example, the parking area may be divided into an area in which a vehicle owned by a resident is allowed to be parked, an area in which a vehicle owned by a regular supplier is allowed to be parked, an area in which a vehicle owned by a guest is allowed to be parked, and the like. In that case, the imaging device 101 and the gate device 103 are installed at a boundary (entrance or exit) of each of the areas, or the like, and the passage control system 100 controls passage of vehicles so that each vehicle can enter only an area in which the vehicle is allowed to be parked.

For example, in a case of a parking area of a company, vehicles allowed to be parked are limited to vehicles (the automobile 110, for example) owned by the company, an employee of the company, a regular supplier, a guest invited by the company, and the like. Information of these vehicles can be registered in advance. The imaging device 101 and the gate device 103 are installed at an entrance, exit, or the like of the parking area, and the control device 102 is installed in a management office within premises of the company, or the like. On the basis of captured images and information registered in advance, the passage control system 100 controls passage of vehicles so as to permit only entering and exiting of vehicles owned by the company, an employee of the company, a regular supplier, a guest invited by the company, and the like.

Furthermore, for example, the parking area may be divided into an area in which a vehicle owned by the company is allowed to be parked, an area in which a vehicle owned by an employee is allowed to be parked, an area in which a vehicle owned by a regular supplier is allowed to be parked, an area in which a vehicle owned by a guest is allowed to be parked, and the like. In that case, the imaging device 101 and the gate device 103 are installed at a boundary (entrance or exit) of each of the areas, or the like, and the passage control system 100 controls passage of vehicles so that each vehicle can enter only an area in which the vehicle is allowed to be parked.

For example, in a case of a parking area of a commercial facility such as a supermarket or a department store, a vehicle (the automobile 110, for example) owned by a customer or the like of the commercial facility is allowed to be parked. That is, basically, any vehicle is allowed to be parked. The imaging device 101 and the gate device 103 are installed at an entrance, exit, or the like of the parking area, and the control device 102 is installed in a management office in the commercial facility, or the like. The passage control system 100 controls passage of vehicles so as to permit only an entered vehicle to exit.

Furthermore, for example, vehicles owned by a company in the commercial facility, a worker thereof, a regular supplier, or the like may also be allowed to be parked. Information of these vehicles can be registered in advance. The passage control system 100 can identify these vehicles on the basis of captured images and information registered in advance, and control passage thereof.

Furthermore, for example, the parking area may be divided into an area in which a vehicle owned by the company is allowed to be parked, an area in which a vehicle owned by an employee is allowed to be parked, an area in which a vehicle owned by a regular supplier is allowed to be parked, an area in which a vehicle owned by a guest is allowed to be parked, and the like. In that case, the imaging device 101 and the gate device 103 are installed at a boundary (entrance or exit) of each of the areas, or the like, and the passage control system 100 controls passage of vehicles so that each vehicle can enter only an area in which the vehicle is allowed to be parked.

For example, in a case of a parking area of a hotel, vehicles (the automobile 110, for example) owned by the hotel, a worker thereof, a regular supplier, an overnight guest, a non-overnight guest (a user of a facility in the hotel, or the like), or the like are allowed to be parked. Information of vehicles owned by the hotel, a worker thereof, and a regular supplier can be registered in advance. Information of vehicles owned by an overnight guest or a non-overnight guest may or may not be registered in advance. The imaging device 101 and the gate device 103 are installed at an entrance, exit, or the like of the parking area, and the control device 102 is installed in a management office in the hotel, or the like. For vehicles of which information is registered in advance, the passage control system 100 controls passage thereof, on the basis of captured images and information registered in advance. Furthermore, for vehicles of which information is not registered in advance, the passage control system 100 controls passage of vehicles so as to permit only an entered vehicle to exit.

Furthermore, for example, the parking area may be divided into an area in which a vehicle owned by the hotel is allowed to be parked, an area in which a vehicle owned by a worker is allowed to be parked, an area in which a vehicle owned by a regular supplier is allowed to be parked, an area in which a vehicle owned by an overnight guest is allowed to be parked, an area in which a vehicle owned by a non-overnight guest is allowed to be parked, and the like. In that case, the imaging device 101 and the gate device 103 are installed at a boundary (entrance or exit) of each of the areas, or the like, and the passage control system 100 controls passage of vehicles so that each vehicle can enter only an area in which the vehicle is allowed to be parked.

For example, in a case of a tollgate of a toll road, the imaging device 101 to the gate device 103 are installed at an entrance, exit, or the like (the tollgate or the like) of the toll road. In this case, basically, any vehicle (the automobile 110, for example) passing through the toll road is allowed to pass through. The passage control system 100 controls passage of vehicles so as to, for example, permit only a vehicle that has entered the toll road and paid an appropriate toll to exit.

Note that, although one each of the imaging device 101 to the gate device 103 are illustrated in FIG. 1, the number of these devices is arbitrary.

For example, a plurality of imaging devices 101 may be provided. For example, an imaging device 101 for detecting a license plate attached to a front of the automobile 110 and an imaging device 101 for detecting a license plate attached to a rear of the automobile 110 may be provided. In that case, the control device 102 may detect the license plate on the front of the automobile 110 and the license plate on the rear of the automobile 110 from captured images supplied from both the imaging devices 101, perform character recognition, and compare both the character recognition results, thereby deriving a character recognition result. With this arrangement, a more accurate character recognition result can be obtained.

Furthermore, for example, one control device 102 may control a plurality of combinations of the imaging device 101 and the gate device 103. For example, the imaging devices 101 and the gate devices 103 may be installed at a plurality of places such as an entrance and an exit of a parking area, and controlled by one control device 102. With this arrangement, the control device 102 can perform control by sharing information obtained at a plurality of places. For example, to control the gate device 103 installed at the exit, the control device 102 can utilize information obtained from a captured image of the automobile 110, the captured image being generated in the imaging device 101 installed at the entrance of the parking area.

Furthermore, a plurality of control devices 102 may share information and perform control in cooperation. Furthermore, the control device 102 may be installed at any place, and may be installed at a place different from an installation place of the imaging device 101 or the gate device 103. For example, the control device 102 may be installed outside of the parking area or facility in which the imaging device 101 and the gate device 103 are installed. For example, a plurality of passage control systems 100 may be controlled in a central management server or the like. In that case, the control devices 102 of the respective passage control systems 100 may communicate with the central management server, share information, and perform processing related to control in cooperation. With this arrangement, the control devices 102 of the respective passage control systems 100 can perform control by sharing information obtained in the plurality of passage control systems 100.

Furthermore, the imaging device 101, the control device 102, and the gate device 103 may be integrated with one another. For example, the imaging device 101 and the control device 102 may be integrated, and imaging, analysis of a captured image, and opening/closing of the gate may be performed in one device. Furthermore, for example, the imaging device 101 and the gate device 103 may be integrated, and imaging and opening/closing of the gate may be performed in one device. Moreover, for example, the control device 102 and the gate device 103 may be integrated, and an image analysis of a captured image and opening/closing of the gate may be performed in one device. Needless to say, the imaging device 101, the control device 102, and the gate device 103 may be integrated, and all of the processing may be performed in one device.

<Imaging Device>

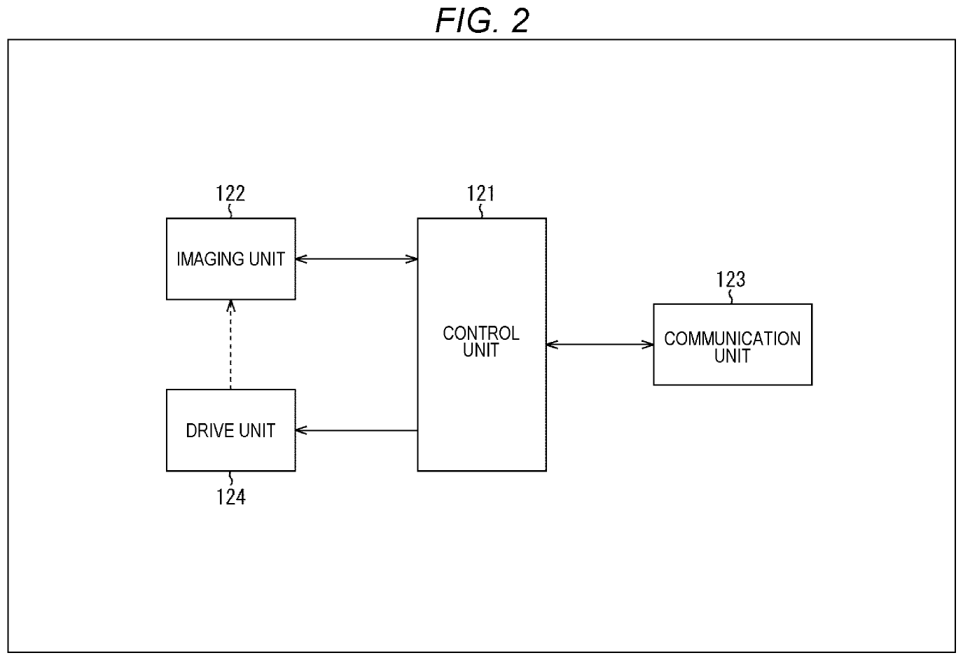

Next, a configuration of each device will be described. FIG. 2 is a block diagram illustrating an example of a main configuration of the imaging device 101 that is one aspect of an information processing device to which the present technology is applied. As illustrated in FIG. 2, the imaging device 101 has a control unit 121, an imaging unit 122, a communication unit 123, and a drive unit 124.

The control unit 121 controls the imaging unit 122, the communication unit 123, and the drive unit 124 to perform processing related to imaging. For example, the control unit 121 can cause the imaging unit 122 to capture an image a subject and acquire the captured image. Furthermore, the control unit 121 can supply the communication unit 123 with the captured image, and cause the communication unit 123 to transmit the captured image to the control device 102. Moreover, the control unit 121 can acquire control information supplied from the control device 102 via the communication unit 123. Furthermore, the control unit 121 can control the imaging unit 122 and the drive unit 124 according to the control information.

The control unit 121 can have any configuration. For example, the control unit 121 may include a logic circuit that achieves the above-described processing. Furthermore, the control unit 121 may have, for example, a central processing unit (CPU), a read only memory (ROM), a random access memory (RAM), and the like, and execute a program by using the CPU, the ROM, the RAM, and the like to achieve the above-described processing. Needless to say, the control unit 121 may have both the configurations and part of the above-described processing may be achieved by the logic circuit, and another may be achieved by executing the program.

The imaging unit 122 has an optical system or a light receiving element, and performs processing related to imaging of the subject. For example, the imaging unit 122 is controlled by the control unit 121, and can capture an image of the subject (the automobile 110, for example) and generate a captured image including the subject (for example, a captured image including the automobile 110). At that time, the imaging unit 122 may generate, as a captured image including the automobile 110, a single still image, a plurality of still images, or a moving image. Needless to say, the imaging unit 122 may generate both a captured image of a moving image and a captured image of a still image. Furthermore, the imaging unit 122 can supply the control unit 121 with the captured image (the still image, the moving image, or both thereof).

Note that the imaging unit 122 can be controlled by the control unit 121 to perform imaging parameter setting. Furthermore, the drive unit 124 drives a movable part of the imaging unit 122, for example, by which the imaging unit 122 can perform an imaging orientation setting, a zoom position setting, focusing (so-called autofocus), aperture adjustment, or the like.

The imaging unit 122 can have any configuration, in addition to the above-described optical system, light receiving element, and the like. For example, the imaging unit 122 may include a logic circuit that achieves the above-described processing by using the optical system or the light receiving element. Furthermore, the imaging unit 122 may have, for example, a CPU, a ROM, a RAM, and the like, and execute a program by using the CPU, the ROM, the RAM, and the like to achieve the above-described processing by using the optical system or the light receiving element. Needless to say, the imaging unit 122 may have both the configurations, and part of the above-described processing may be achieved by the logic circuit and another may be achieved by executing the program.

The communication unit 123 has a communication interface and communicates with another device via the communication interface. A method (standard) for the communication is arbitrary, and may be wireless communication, wired communication, or both thereof.

For example, the communication unit 123 can communicate with the control device 102 and supply the captured image supplied from the control unit 121 to the control device 102. Furthermore, the communication unit 123 can communicate with the control device 102, acquire control information supplied from the control device 102, and supply the control information to the control unit 121.

The communication unit 123 can have any configuration, in addition to the above-described communication interface. For example, the communication unit 123 may include a logic circuit that achieves the above-described processing by using the communication interface. Furthermore, the communication unit 123 may have, for example, a CPU, a ROM, a RAM, and the like, and execute a program by using the CPU, the ROM, the RAM, and the like to achieve the above-described processing by using the communication interface. Needless to say, the communication unit 123 may have both the configurations, and part of the above-described processing may be achieved by the logic circuit and another may be achieved by executing the program.

The drive unit 124 has an actuator or the like, and drives the movable part of the imaging unit 122. For example, the control unit 121 controls the drive unit 124, by which the drive unit 124 can drive the movable part of the imaging unit 122 to perform an imaging orientation setting, a zoom position setting, focusing (so-called autofocus), aperture adjustment, or the like.

The drive unit 124 can have any configuration, in addition to the above-described actuator or the like. For example, the drive unit 124 may include a logic circuit that achieves the above-described processing by using the actuator or the like. Furthermore, the drive unit 124 may have, for example, a CPU, a ROM, a RAM, and the like, and execute a program by using the CPU, the ROM, the RAM, and the like to achieve the above-described processing by using the actuator or the like. Needless to say, the drive unit 124 may have both the configurations, and part of the above-described processing may be achieved by the logic circuit and another may be achieved by executing the program.

<Control Device>

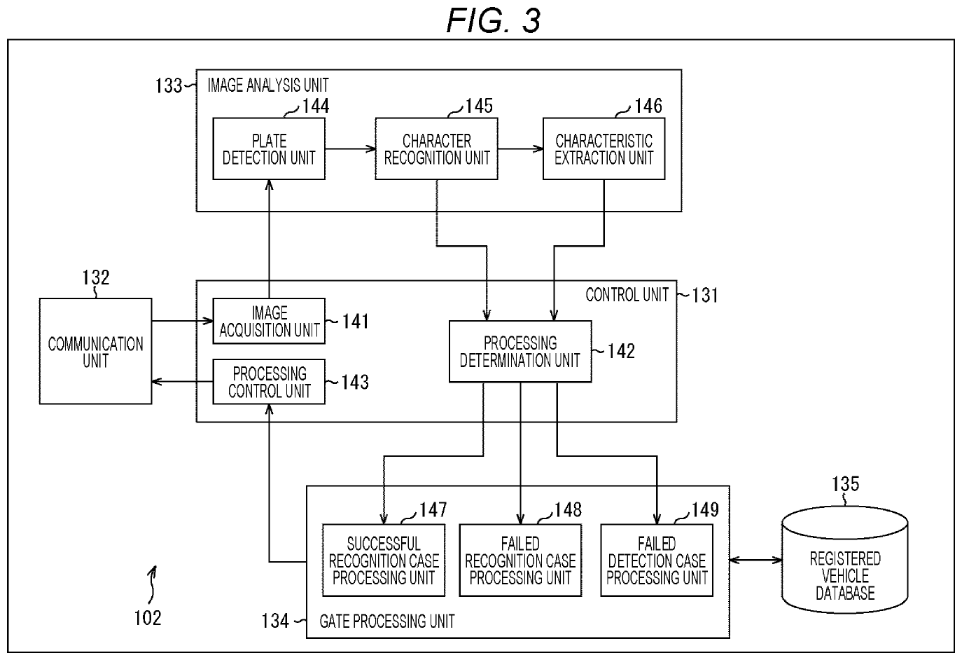

FIG. 3 is a block diagram illustrating an example of a main configuration of the control device 102 that is one aspect of the information processing device to which the present technology is applied. As illustrated in FIG. 2, the control device 102 has a control unit 131, a communication unit 132, an image analysis unit 133, a gate processing unit 134, and a registered vehicle database 135.

The control unit 131 controls the communication unit 132, the image analysis unit 133, and the gate processing unit 134 to perform various kinds of processing.

The control unit 131 has, as a functional block, an image acquisition unit 141, a processing determination unit 142, and a processing control unit 143, for example.

The image acquisition unit 141 performs processing related to acquisition of a captured image. For example, the image acquisition unit 141 can acquire a captured image supplied from the imaging device 101 via the communication unit 132. Furthermore, the image acquisition unit 141 can supply the acquired captured image to the image analysis unit 133 (a plate detection unit 144).

The processing determination unit 142 determines processing to be executed on the basis of an image analysis result by the image analysis unit 133. For example, on the basis of a captured image analysis result supplied from the image analysis unit 133 (a character recognition result or the like supplied from a character recognition unit 145, information regarding a characteristic of the automobile 110, the information being supplied from a characteristic extraction unit 146, or the like), the processing determination unit 142 can determine what processing is to be performed. Furthermore, the processing determination unit 142 can cause the gate processing unit 134 (a successful recognition case processing unit 147, a failed recognition case processing unit 148, or a failed detection case processing unit 149) to execute processing on the basis of the determination result.

The processing control unit 143 performs processing related to control of the imaging device 101 and the gate device 103. For example, the processing control unit 143 can acquire control information supplied from the gate processing unit 134 and supply the control information to the gate device 103 via the communication unit 132. That is, the processing control unit 143 can cause the gate device 103 to execute processing corresponding to the control information. Furthermore, via the communication unit 132, the processing control unit 143 can supply the gate device 103 with control information for controlling the imaging device 101 (the imaging unit 122 or the drive unit 124). That is, the processing control unit 143 can cause the imaging device 101 to execute processing corresponding to the control information.

The control unit 131 can have any configuration. For example, the control unit 131 may include a logic circuit that achieves the above-described processing by each of the functional blocks. Furthermore, the control unit 131 may have, for example, a CPU, a ROM, a RAM, and the like, and execute a program by using the CPU, the ROM, the RAM, and the like to achieve processing by each of the functional blocks. Needless to say, the control unit 131 may have both the configurations, and part of the processing by each of the functional blocks may be achieved by the logic circuit and another may be achieved by executing the program.

The communication unit 132 has a communication interface and communicates with another device via the communication interface. A method (standard) for the communication is arbitrary, and may be wireless communication, wired communication, or both thereof.

For example, the communication unit 132 can communicate with the imaging device 101, receive a captured image supplied from the imaging device 101, and supply the captured image to the control unit 131 (the image acquisition unit 141). Furthermore, the communication unit 132 can communicate with the imaging device 101 and the gate device 103, acquire control information supplied from the control unit 131 (the processing control unit 143), and supply the control information to the imaging device 101 and the gate device 103.

The communication unit 132 can have any configuration, in addition to the above-described communication interface. For example, the communication unit 132 may include a logic circuit that achieves the above-described processing by using the communication interface. Furthermore, the communication unit 323 may have, for example, a CPU, a ROM, a RAM, and the like, and execute a program by using the CPU, the ROM, the RAM, and the like to achieve the above-described processing by using the communication interface. Needless to say, the communication unit 132 may have both the configurations, and part of the above-described processing may be achieved by the logic circuit and another may be achieved by executing the program.

The image analysis unit 133 performs processing related to image analysis. The image analysis unit 133 has, as a functional block, the plate detection unit 144, the character recognition unit 145, and the characteristic extraction unit 146.

The plate detection unit 144 performs processing related to license plate detection. For example, the plate detection unit 144 can acquire a captured image (a captured image including the automobile 110) supplied from the image acquisition unit 141. Furthermore, the plate detection unit 144 can perform image analysis on the captured image to detect a license plate. Moreover, the plate detection unit 144 can supply the character recognition unit 145 with information indicating the detection result, and the captured image.

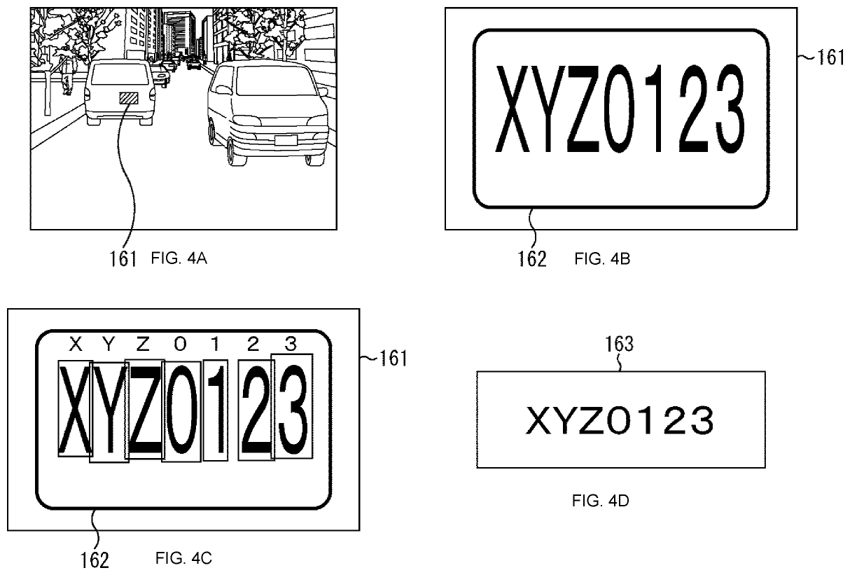

For example, the plate detection unit 144 acquires a captured image as illustrated in A of FIG. 4, and performs, on the captured image, detection of a license plate of the automobile 110. That is, a partial region 161 including the license plate of the automobile 110 is identified.

In a case where the detection is successful (in a case where the partial region 161 can be identified), the plate detection unit 144 cuts the partial region 161 including the detected license plate out of the captured image. As illustrated in B of FIG. 4, in a case where the license plate has been successfully detected, an image of the partial region 161 includes an image of a license plate 162 of the automobile 110.

The plate detection unit 144 supplies the character recognition unit 145 with the image of the partial region 161 as a plate detection result. Furthermore, the plate detection unit 144 supplies the character recognition unit 145 with a captured image (entire image) to be processed.

The character recognition unit 145 performs processing related to character recognition on characters written on the license plate detected by the plate detection unit 144. For example, the character recognition unit 145 can acquire the image of the license plate 162 of the automobile 110 (image of the partial region 161) and the captured image (entire image) that are supplied from the plate detection unit 144. Furthermore, in a case where the plate detection unit 144 has successfully detected the license plate, the character recognition unit 145 can perform character recognition on the characters written on the detected license plate. Moreover, the character recognition unit 145 can supply the control unit 131 (the processing determination unit 142) with information indicating the character recognition result. Furthermore, the character recognition unit 145 can supply the control unit 131 (the processing determination unit 142) with the captured image (entire image) and the image of the license plate 162 of the automobile 110. Moreover, the character recognition unit 145 can supply the characteristic extraction unit 146 with the information indicating the character recognition result, the captured image (entire image), and the image of the license plate 162 of the automobile 110.

For example, as illustrated in C of FIG. 4, the character recognition unit 145 performs character recognition for each of characters written on the license plate 162 included in the image of the partial region 161. In a case of C of FIG. 4, each of characters “X”, “Y”, “Z”, “0”, “1”, “2”, and “3” written on the license plate 162 is recognized. Therefore, as illustrated in D of FIG. 4, the character recognition unit 145 can recognize a vehicle registration number 163 (XYZ0123) written on the license plate 162.

In a case where the recognition of the vehicle registration number 163 is successful, the character recognition unit 145 supplies the processing determination unit 142 with information indicating the recognized vehicle registration number 163, as information indicating the character recognition result. Furthermore, the character recognition unit 145 supplies the processing determination unit 142 with the captured image (entire image) and the image of the license plate 162 of the automobile 110.

In a case where the recognition of the vehicle registration number 163 has failed (for example, in a case where character recognition of some or all of the characters written on the license plate 162 has failed), the character recognition unit 145 supplies the processing determination unit 142 with information indicating a character successfully recognized, as information indicating the character recognition result. For example, in a case where some of the characters in the vehicle registration number 163 can be recognized, the character recognition unit 145 supplies information indicating the recognized characters, as information indicating the character recognition result. In a case where character recognition of all the characters has failed, the character recognition unit 145 supplies information indicating the failure, as the information indicating the character recognition result. Furthermore, the character recognition unit 145 supplies the processing determination unit 142 with the captured image (entire image) and the image of the license plate 162 of the automobile 110.

Moreover, in a case where the recognition of the vehicle registration number 163 has failed, the character recognition unit 145 supplies the captured image (entire image) to the characteristic extraction unit 146.

The characteristic extraction unit 146 performs image analysis on the captured image, and extracts a characteristic (also referred to as characteristic information) of the automobile 110 (vehicle) included in the captured image. That is, in a case where the character recognition unit 145 cannot recognize at least a part of the vehicle registration number written on the license plate, the characteristic extraction unit 146 extracts characteristic information from the captured image. The characteristic information to be extracted may be any characteristic information. For example, at least any one of a vehicle name, vehicle type, model, and vehicle color of the automobile 110 may be identified and extracted. Needless to say, other characteristic information may be extracted. The characteristic extraction unit 146 supplies the processing determination unit 142 with the extracted characteristic information as the image analysis result.

The image analysis unit 133 can have any configuration. For example, the image analysis unit 133 may include a logic circuit that achieves the above-described processing by each of the functional blocks. Furthermore, the image analysis unit 133 may have, for example, a CPU, a ROM, a RAM, and the like, and execute a program by using the CPU, the ROM, the RAM, and the like to achieve the processing by each of the functional blocks. Needless to say, the image analysis unit 133 may have both the configurations, and part of the processing by each of the functional blocks may be achieved by the logic circuit and another may be achieved by executing the program.

A method for these image analyses (license plate detection, character recognition, and extraction of a characteristic of a vehicle) is arbitrary. For example, the image analysis unit 133 may perform these image analyses by using an evaluator generated by using learning (so-called machine learning, deep learning, or the like). For example, the image analysis unit 133 may generate the evaluator by performing learning by inputting a captured image (entire image), an image of the license plate 162 of the automobile 110, information indicating the vehicle registration number 163, information indicating a characteristic of the vehicle, or the like as learning data, to a predetermined calculation model (for example, a calculation model based on a multilayer neural network), and may perform the above-described image analyses by using the evaluator.

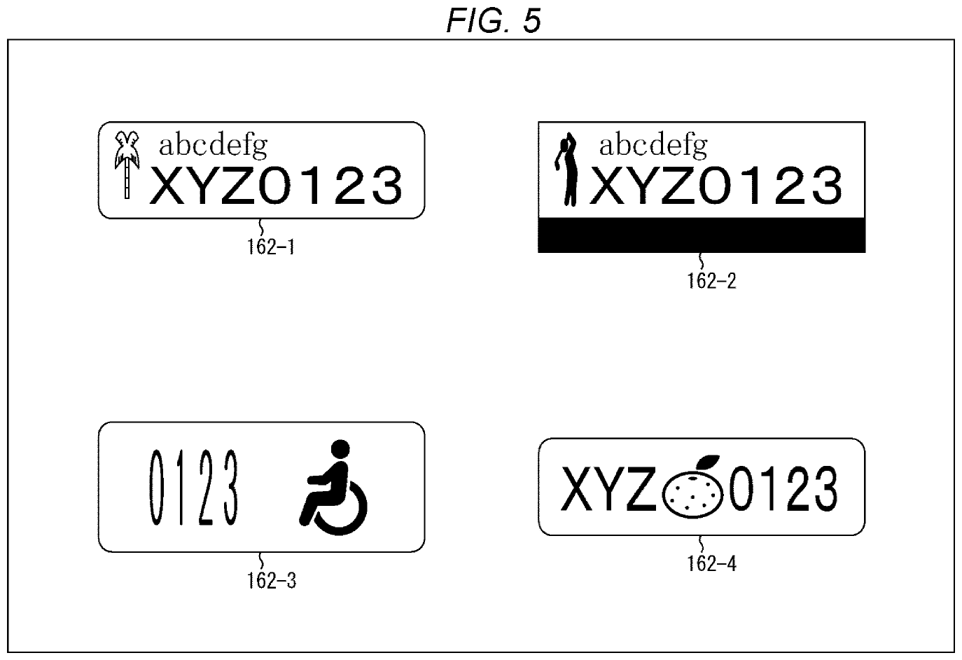

For example, as in license plates 162-1 to 162-4 illustrated in FIG. 5, in some countries, various designs are approved as designs of license plates (or characters or the like written thereon). In such a case, by performing image analysis by using a learning result as described above, the image analysis unit 133 can perform image analysis (license plate detection, character recognition, extraction of a characteristic of a vehicle, or the like) more accurately than performing processing based on a simple image characteristic extraction.

Returning to FIG. 3, the gate processing unit 134 performs processing related to control of the gate device 103. The gate processing unit 134 has, as a functional block, the successful recognition case processing unit 147, the failed recognition case processing unit 148, and the failed detection case processing unit 149.

The processing determination unit 142 controls which processing unit among the successful recognition case processing unit 147, the failed recognition case processing unit 148, and the failed detection case processing unit 149 performs processing according to the image analysis result supplied from the image analysis unit 133.

The successful recognition case processing unit 147 is controlled by the processing determination unit 142, and performs processing in a case where the license plate has been successfully detected and the characters have been successfully recognized. That is, in a case where the license plate has been successfully detected and the characters have been successfully recognized, the processing determination unit 142 controls the successful recognition case processing unit 147 to execute the processing.

The processing performed by the successful recognition case processing unit 147 may be any processing. For example, the successful recognition case processing unit 147 acquires, via the processing determination unit 142, information indicating the vehicle registration number 163, and refers to the registered vehicle database 135 for the vehicle registration number 163. In a case where registration information including a vehicle registration number matching the vehicle registration number 163 is in the registered vehicle database 135, the successful recognition case processing unit 147 generates control information for opening the gate 103A and supplies the control information to the gate device 103 via the processing control unit 143.

The failed recognition case processing unit 148 is controlled by the processing determination unit 142, and performs processing in a case where the license plate has been successfully detected and the character recognition has failed. That is, in a case where the license plate has been successfully detected, and the character recognition of some or all of the characters written on the license plate has failed, the processing determination unit 142 controls the failed recognition case processing unit 148 to execute the processing.

The processing performed by the failed recognition case processing unit 148 may be any processing. For example, the failed recognition case processing unit 148 acquires, via the processing determination unit 142, information indicating a recognized character or information indicating that recognition of all of the characters has failed, and information indicating a characteristic of the automobile 110. Furthermore, the failed recognition case processing unit 148 refers to the registered vehicle database 135 for those pieces of information. In a case where registration information including information matching those pieces of information is in the registered vehicle database 135, the failed recognition case processing unit 148, for example, judges opening or closing of the gate, and if there is no problem, generates control information for opening the gate 103A and supplies the control information to the gate device 103 via the processing control unit 143. A method for judging opening or closing of a gate is arbitrary. Furthermore, the failed recognition case processing unit 148 can also perform other arbitrary processing instead of performing the control to open the gate.

The failed detection case processing unit 149 is controlled by the processing determination unit 142, and performs processing in a case where the license plate detection has failed. That is, in a case where detection of a license plate has failed (for example, in a case where a license plate is not installed on the automobile 110, or the like), the processing determination unit 142 controls the failed detection case processing unit 149 to execute the processing.

The processing performed by the failed detection case processing unit 149 may be any processing. For example, the failed detection case processing unit 149 generates control information for not opening the gate 103A (or control information for closing the gate 103A opened), and supplies the control information to the gate device 103 via the processing control unit 143.

The gate processing unit 134 can have any configuration. For example, the gate processing unit 134 may include a logic circuit that achieves the above-described processing by each of the functional blocks. Furthermore, the gate processing unit 134 may have, for example, a CPU, a ROM, a RAM, and the like, and execute a program by using the CPU, the ROM, the RAM, and the like to achieve the processing by each of the functional blocks. Needless to say, the gate processing unit 134 may have both the configurations, and part of the processing by each of the functional blocks may be achieved by the logic circuit and another may be achieved by executing the program.

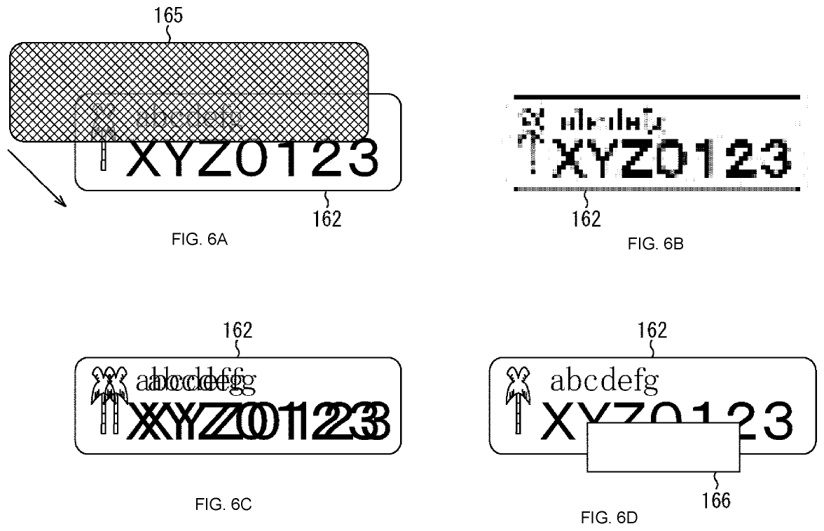

In an actual environment, there may be a case where character recognition of characters written on a license plate fails due to various factors, even if the license plate can be detected. For example, there may be a case where character recognition fails due to an angle of a license plate, reflected light, dirt, or the like. Furthermore, for example, as illustrated in A of FIG. 6, there may be a case where character recognition fails because a translucent plate 165 for protection or prevention of detection by an infrared sensor is attached to a surface of the license plate 162.

Moreover, for example, there may be a case where surrounding is too dark, or as illustrated in B of FIG. 6, resolution of the license plate 162 is too low in a captured image, and therefore character recognition fails. Furthermore, for example, as illustrated in C of FIG. 6, there may be a case where character recognition fails due to blurring occurring with the characters written on the license plate 162 in a captured image.

Moreover, for example, as illustrated in D of FIG. 6, there may be a case where character recognition fails because a part of or the entire (characters written on the) license plate 162 is hidden due to, for example, some object 166 being installed on a front surface of the license plate 162, or the like. Needless to say, there may also be a case where character recognition fails due to a factor other than these examples.

In such a case also, in a conventional method, control is unconditionally performed for not opening the gate 103A (or for closing the gate 103A in a case where the gate is already open), similarly to a case where detection of the license plate 162 fails (that is, in a case where it is determined that the license plate is not installed).

However, in an actual environment, there are many factors that cause a failure of character recognition as described above, and it has been difficult to always succeed in character recognition accurately. Therefore, with such a method, there has been a possibility of an increasing number of cases where the gate 103A does not open for the automobile 110 that is originally allowed to pass, reducing convenience as a system.

Therefore, the failed recognition case processing unit 148 performs processing in a case where a license plate has been successfully detected and the character recognition has failed. For example, the gate 103A is opened or other processing is performed. With this arrangement, it is possible to perform processing more appropriate to a situation. In particular, the characteristic extraction unit 146 analyzes a characteristic of the vehicle, and the failed recognition case processing unit 148 performs processing on the basis of the analysis result (that is, the characteristic of the vehicle), by which processing more appropriate to a situation can be performed.

The registered vehicle database 135 is a database in which information regarding a vehicle is registered in advance, and is formed in, for example, a storage unit or the like. The vehicle registered in the registered vehicle database 135 is referred to as a registered vehicle. That is, the registered vehicle database 135 is a database that stores information regarding a registered vehicle.

For example, in a case of a parking area of a condominium, information regarding a vehicle owned by a resident of the condominium, a vehicle owned by a regular supplier, a vehicle owned by a guest invited by a resident (a vehicle reserved for entering), and the like may be registered in the registered vehicle database 135.

For example, in a case of a parking area of a company, information regarding a vehicle owned by the company, a vehicle owned by an employee of the company, a vehicle owned by a regular supplier, a vehicle owned by a guest invited by the company (a vehicle reserved for entering), and the like may be registered in the registered vehicle database 135.

For example, in a case of a parking area of a commercial facility such as a supermarket or a department store, information regarding a vehicle owned by a company in the commercial facility, a vehicle owned by a worker thereof, a vehicle owned by a regular supplier or the like, and the like may be registered in the registered vehicle database 135.

For example, in a case of a parking area of a hotel, information regarding a vehicle owned by the hotel, a vehicle owned by a worker of the hotel, a vehicle owned by a regular supplier, and the like may be registered in the registered vehicle database 135.

The registered vehicle database 135 compares a vehicle registration number, characteristics of a vehicle, or the like referred to by the gate processing unit 134 (the successful recognition case processing unit 147 or the failed recognition case processing unit 148) with information of each registered vehicle, and returns a match or a mismatch. In a case of a match, information regarding the matched registered vehicle is also returned.

<Registration Information in Registered Vehicle Database>

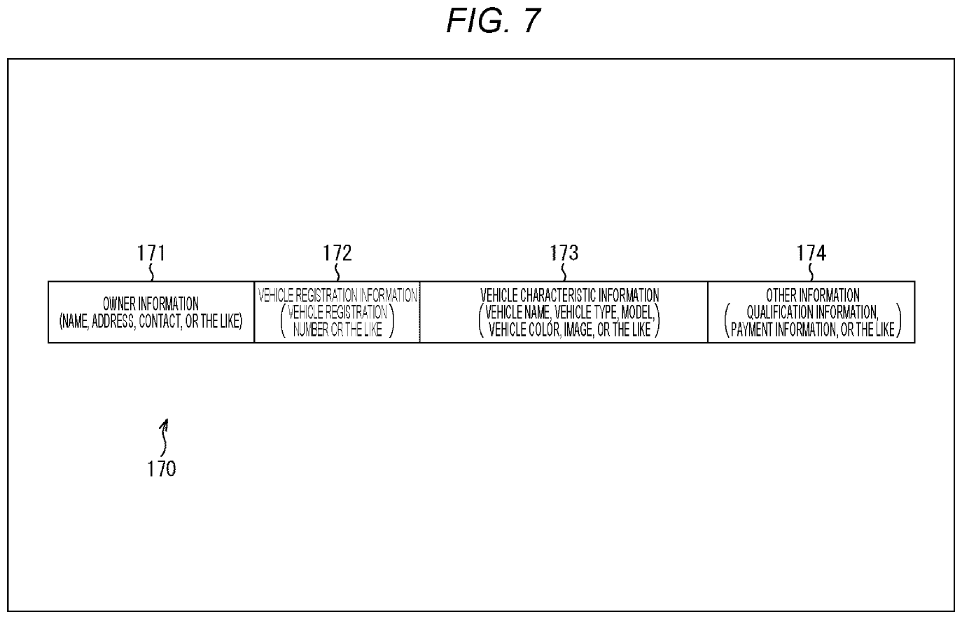

FIG. 7 illustrates an example of information registered in the registered vehicle database 135. Registration information 170 illustrated in FIG. 7 is information regarding a registered vehicle. The registration information 170 may include, for example, owner information 171, vehicle registration information 172, vehicle characteristic information 173, and other information 174.

The owner information 171 is information regarding an owner of the registered vehicle. For example, information of a name, an address, a contact, or the like of the owner may be included in the owner information 171. Needless to say, the owner information 171 may include any other information.

The vehicle registration information 172 is information which is related to a registered vehicle, and is registered in a national government, a local government, or the like. For example, a vehicle registration number or the like may be included in the vehicle registration information 172. Needless to say, the vehicle registration information 172 may include any other information.

The vehicle characteristic information 173 is information regarding a characteristic of the registered vehicle. For example, information of a vehicle name, a vehicle type, a model, a vehicle color, or the like may be included in the vehicle characteristic information 173. Furthermore, the vehicle characteristic information 173 may include a captured image of the registered vehicle. Needless to say, the vehicle characteristic information 173 may include any other information.

The other information 174 is other information related to the registered vehicle. For example, the other information 174 may include qualification information indicating an area or the like that the registered vehicle is allowed to enter, or payment information that is information regarding payment related to the parking or the like by the registered vehicle. Needless to say, the other information 174 may include any other information.

Furthermore, the payment information may include, for example, information indicating a payment method. Furthermore, the payment information may include information indicating payment processing (whether or not the payment has been completed). Needless to say, the payment information may include any other information.

<Gate Device>

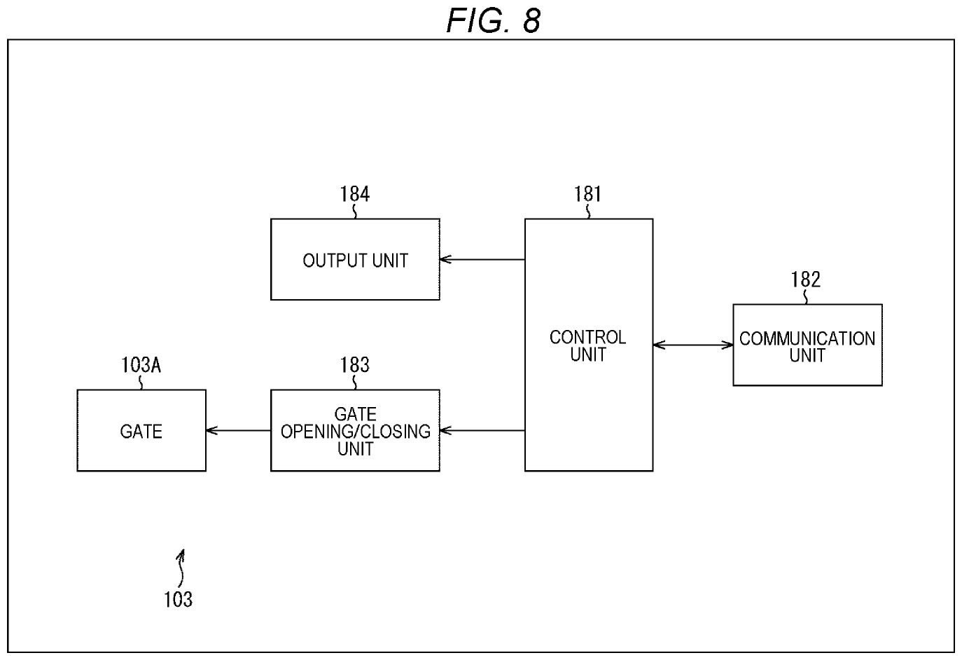

FIG. 8 is a block diagram illustrating an example of a main configuration of the gate device 103 that is one aspect of the information processing device to which the present technology is applied. As illustrated in FIG. 8, the gate device 103 has, for example, a control unit 181, a communication unit 182, a gate opening/closing unit 183, and an output unit 184, in addition to the above-described gate 103A.

The control unit 181 controls the communication unit 182, the gate opening/closing unit 183, and the output unit 184 to perform processing related to opening/closing of the gate and the like. For example, the control unit 181 can acquire control information supplied from the control device 102 via the communication unit 182. Furthermore, the control unit 181 can control the gate opening/closing unit 183 and the output unit 184 according to the control information.

The control unit 181 can have any configuration. For example, the control unit 181 may include a logic circuit that achieves the above-described processing. Furthermore, the control unit 181 may have, for example, a CPU, a ROM, a RAM, and the like, and execute a program by using the CPU, the ROM, the RAM, and the like to achieve the above-described processing. Needless to say, the control unit 181 may have both the configurations, and part of the above-described processing may be achieved by the logic circuit and another may be achieved by executing the program.

The communication unit 182 has a communication interface and communicates with another device via the communication interface. A method (standard) for the communication is arbitrary, and may be wireless communication, wired communication, or both thereof. For example, the communication unit 182 can communicate with the control device 102, acquire control information supplied from the control device 102, and supply the control information to the control unit 181.

The communication unit 182 can have any configuration, in addition to the above-described communication interface. For example, the communication unit 182 may include a logic circuit that achieves the above-described processing by using the communication interface. Furthermore, the communication unit 182 may have, for example, a CPU, a ROM, a RAM, and the like, and execute a program by using the CPU, the ROM, the RAM, and the like to achieve the above-described processing by using the communication interface. Needless to say, the communication unit 182 may have both the configurations, and part of the above-described processing may be achieved by the logic circuit and another may be achieved by executing the program.

The gate opening/closing unit 183 includes an actuator or the like, and opens and closes the gate 103A under control of the control unit 121.

The gate opening/closing unit 183 can have any configuration, in addition to the above-described actuator or the like. For example, the gate opening/closing unit 183 may include a logic circuit that achieves the above-described processing by using the actuator or the like. Furthermore, the gate opening/closing unit 183 may have, for example, a CPU, a ROM, a RAM, and the like, and execute a program by using the CPU, the ROM, the RAM, and the like to achieve the above-described processing by using the actuator or the like. Needless to say, the gate opening/closing unit 183 may have both the configurations, and part of the above-described processing may be achieved by the logic circuit and another may be achieved by executing the program.

The output unit 184 includes, for example, a display device (a monitor, for example) that displays an image or the like and an audio output device (a speaker, for example) that outputs audio, and outputs an image or audio by using the device. For example, the output unit 184 is controlled by the control unit 181, and can display a message or the like to the occupant of the automobile 110 or output audio. For example, the output unit 184 can provide, as the message, information of a passage route or an available parking space, guidance on payment, information related to processing content, or the like. Needless to say, the output unit 184 can output arbitrary information other than these examples.

The output unit 184 can have any configuration, in addition to the above-described display device, audio output device, and the like. For example, the output unit 184 may include a logic circuit that achieves the above-described processing by using the display device, the audio output device, or the like. Furthermore, the output unit 184 may have, for example, a CPU, a ROM, a RAM, and the like, and execute a program by using the CPU, the ROM, the RAM, and the like to achieve the above-described processing by using the display device, the audio output device, or the like. Needless to say, the output unit 184 may have both the configurations, and part of the above-described processing may be achieved by the logic circuit and another may be achieved by executing the program.

<Flow of Passage Control Processing>

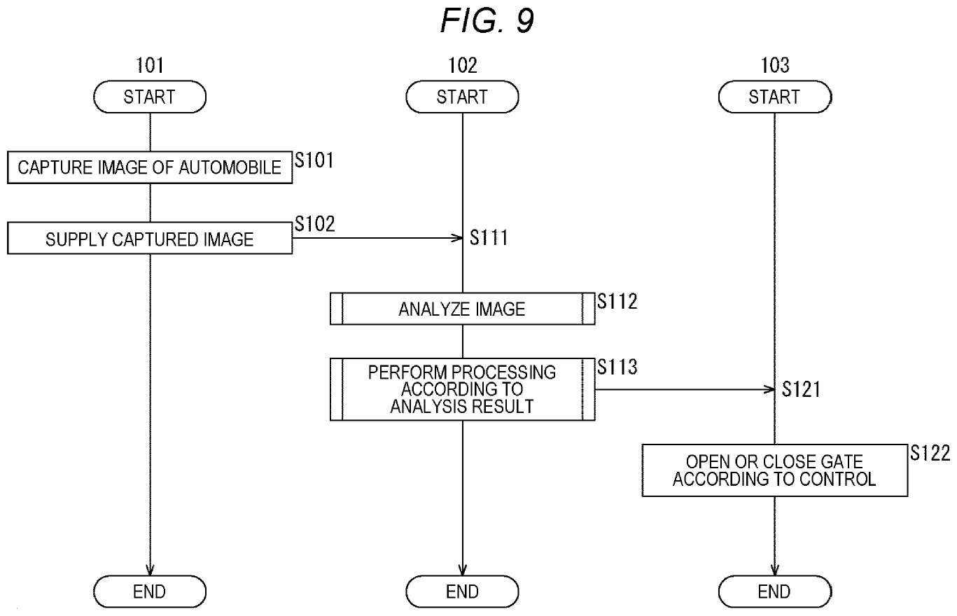

The passage control system 100 configured as described above performs the above-described processing by executing passage control processing. An example of a flow of the passage control processing will be described with reference to a flowchart in FIG. 9.

In Step S101, the imaging unit 122 of the imaging device 101 captures an image of the automobile 110 (in a vicinity of the gate device 103) entering the angle of view, and generates a captured image.

In Step S102, the control unit 121 supplies the control device 102 with the captured image generated in Step S101 via the communication unit 123. In Step S111, the image acquisition unit 141 of the control device 102 acquires the captured image via the communication unit 132 and supplies the captured image to the image analysis unit 133.

In Step S112, the image analysis unit 133 performs image analysis processing on the captured image. Details of the image analysis processing will be described later.

When the image analysis processing ends, in Step S113, the processing determination unit 142 and the gate processing unit 134 execute control processing, and perform processing corresponding to the analysis result of Step S112.

The processing control unit 143 supplies, via the communication unit 132, the gate device 103 with the control information generated by the control processing. In Step S121, the control unit 181 of the gate device 103 acquires the control information via the communication unit 182. The control unit 181 controls the gate opening/closing unit 183 and the output unit 184 as necessary, on the basis of the control information.

In Step S122, the gate opening/closing unit 183 opens or closes the gate 103A according to the control. Furthermore, the output unit 184 displays an image or outputs audio according to the control.

<Flow of Image Analysis Processing>

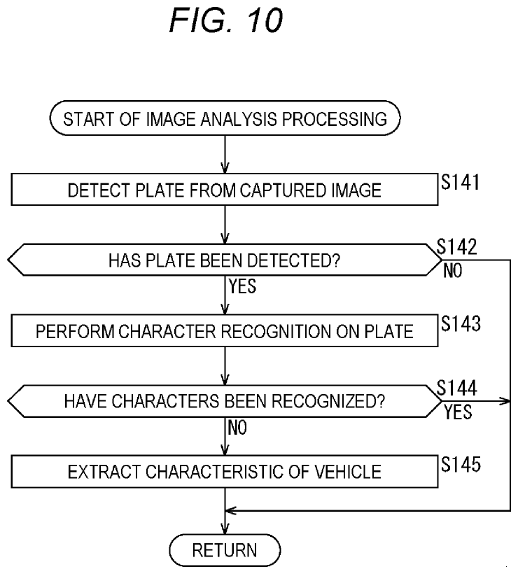

Next, an example of a flow of image analysis processing executed in Step S112 in FIG. 9 will be described with reference to a flowchart in FIG. 10.

In Step S141, the plate detection unit 144 detects a license plate from the captured image of the automobile 110.

In Step S142, the plate detection unit 144 determines whether or not a license plate has been successfully detected. In a case where it is determined to be successful, the processing proceeds to Step S143.

In Step S143, the character recognition unit 145 performs character recognition on the characters written on the license plate detected in Step S141.

In Step S144, the character recognition unit 145 determines whether or not the characters have been successfully recognized. In a case where it is determined that character recognition has failed for at least some of the characters written on the license plate, the processing proceeds to Step S145.

In Step S145, the characteristic extraction unit 146 performs image analysis on the captured image and extracts a characteristic of the automobile 110 (vehicle). For example, the characteristic extraction unit 146 extracts, from the captured image, a part indicating a characteristic of the automobile 110 as an image, and derives a characteristic (for example, a vehicle name, a vehicle type, a model, a vehicle color, or the like) of the automobile 110 on the basis of the partial image.

When the processing in Step S145 ends, the image analysis processing ends.

Furthermore, in Step S144, in a case where it is determined that all of the characters written on the license plate have been successfully recognized, that is, in a case where the license plate is detected, and it is determined that the vehicle registration number 163 written on the detected license plate is recognized, the image analysis processing ends.

Furthermore, in a case where it is determined in Step S142 that detection of a license plate has failed, the image analysis processing ends.

<Flow of Control Processing>

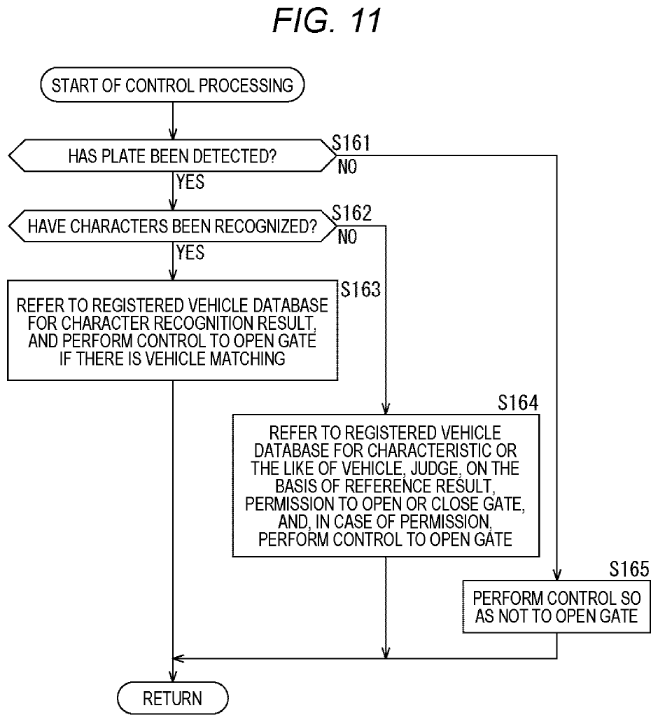

Next, an example of a flow of control processing executed in Step S113 in FIG. 9 will be described with reference to a flowchart in FIG. 11.

In Step S161, on the basis of a result of the image analysis processing (FIG. 10), the processing determination unit 142 determines whether or not the license plate has been successfully detected. In a case where it is determined that a plate has been detected, the processing proceeds to Step S162.

In Step S162, on the basis of the result of the image analysis processing (FIG. 10), the processing determination unit 142 determines whether or not all of the characters written on the license plate have been recognized. In a case where it is determined that all of the characters written on the license plate have been successfully recognized, the processing proceeds to Step S163.

In Step S163, the successful recognition case processing unit 147 performs processing for a case where the license plate has been successfully detected and all of the characters written on the license plate have been successfully recognized. For example, the successful recognition case processing unit 147 refers to the registered vehicle database 135 for a character recognition result (a recognized registered vehicle number). In a case where there is registration information having vehicle registration information 172 including the registered vehicle number matching the character recognition result, the successful recognition case processing unit 147 generates control information for controlling the gate device 103 to open the gate 103A. The processing control unit 143 supplies the control information to the gate device 103 via the communication unit 132.

That is, for example, in a case of a parking area of a condominium, the successful recognition case processing unit 147 refers to the registered vehicle database 135 for the character recognition result (the recognized registered vehicle number), thereby determining whether or not an owner of the automobile 110 is a resident of the condominium, a regular supplier, a guest invited by a resident, or the like, and if so, the successful recognition case processing unit 147 performs control to open the gate.

Furthermore, for example, in a case of a parking area of a company, the successful recognition case processing unit 147 refers to the registered vehicle database 135 for the character recognition result (the recognized registered vehicle number), thereby determining whether or not an owner of the automobile 110 is the company, an employee of the company, a regular supplier, a guest invited by the company, or the like, and if so, the successful recognition case processing unit 147 performs control to open the gate.

Furthermore, for example, in a case of a parking area of a commercial facility such as a supermarket or a department store, the successful recognition case processing unit 147 refers to the registered vehicle database 135 for the character recognition result (the recognized registered vehicle number), thereby determining whether or not an owner of the automobile 110 is a company in the commercial facility, a worker thereof, a regular supplier, or the like, and if so, the successful recognition case processing unit 147 performs control to open the gate.

Furthermore, for example, in a case of a parking area of a hotel, the successful recognition case processing unit 147 refers to the registered vehicle database 135 for the character recognition result (the recognized registered vehicle number), thereby determining whether or not an owner of the automobile 110 is the hotel, a worker thereof, a regular supplier, or the like, and if so, the successful recognition case processing unit 147 performs control to open the gate.

When the processing in Step S163 ends, the control processing ends.

Furthermore, in a case where it is determined in Step S162 that character recognition has failed for some or all of the characters written on the license plate, the processing proceeds to Step S164.

In Step S164, the failed recognition case processing unit 148 performs processing for a case where the license plate has been successfully detected and character recognition has been failed for some or all of the characters written on the license plate. For example, the failed recognition case processing unit 148 refers to the registered vehicle database 135 for the extracted characteristic of the automobile 110. In a case where there is registration information having vehicle characteristic information 173 including information matching a referred characteristic of the automobile 110, the failed recognition case processing unit 148 judges, with a predetermined method, permission to open or close the gate, and in a case of permission, similarly to the case of Step S163, generates control information for controlling the gate device 103 to open the gate 103A. The processing control unit 143 supplies the control information to the gate device 103 via the communication unit 132.

Note that, in this case, the failed recognition case processing unit 148 can also perform processing other than opening the gate 103A. For example, the failed recognition case processing unit 148 may call a manager to perform processing. Furthermore, for example, the failed recognition case processing unit 148 may provide the occupant of the automobile 110 with a notification related to a measure, such as having the occupant of the automobile 110 to present a certificate, an employee identification card, or the like.

Moreover, for example, the failed recognition case processing unit 148 may control execution of payment processing related to passage (or parking) of the vehicle. For example, the failed recognition case processing unit 148 refers to the registered vehicle database 135 for the extracted characteristic of the automobile 110, and on the basis of an introduction result, payment processing may not be performed in a case where there is registration information having a matched characteristic (that is, in a case where the automobile 110 is determined to be a registered vehicle), and payment processing may be performed in a case where the characteristic does not match.

Furthermore, for example, the failed recognition case processing unit 148 may control a setting for a method for payment related to passage (or parking) of the vehicle. For example, the failed recognition case processing unit 148 refers to the registered vehicle database 135 for the extracted characteristic of the automobile 110, and on the basis of an introduction result, control may be performed so that payment processing is performed in automatic withdrawal in a case where there is registration information having a matched characteristic (that is, in a case where the automobile 110 is determined to be a registered vehicle), and control may be performed so that payment processing is performed in cash or the like on a spot in a case where the characteristic does not match.

Moreover, for example, the failed recognition case processing unit 148 may judge permission to open or close the gate 103A according to qualification information included in the other information 174 of the registration information 170. For example, in a case where it is determined from the qualification information that the automobile 110 is allowed to enter an area over the gate 103A, the failed recognition case processing unit 148 may permit the gate 103A to open. That is, the failed recognition case processing unit 148 may generate control information for controlling the gate device 103 to open the gate 103A.

Furthermore, for example, the failed recognition case processing unit 148 may judge the permission to open or close the gate 103A according to not only characteristics of the vehicle but also a security level. There may be a case where, for example, the security level changes according to date and time such as night-time or daytime, or a weekday or a holiday, or, for example, the security level changes according to a situation such as whether or not the parking area is full, or whether or not a very important person is visiting, or the like. It is possible to perform processing more appropriate to a situation.

By the failed recognition case processing unit 148 considering such a security level and judging the permission to open or close the gate 103A corresponding to the security level, the passage control system 100 can perform processing more appropriate to a situation, that is, for example, the passage control system 100 permits the automobile 110 to pass during daytime and controls the gate to open, and prohibits the same automobile 110 from passing during night-time and controls the gate 103A not to open.

When the processing in Step S164 ends, the control processing ends.

Furthermore, in a case where it is determined in Step S161 that detection of a license plate has failed, the processing proceeds to Step S165.

In Step S165, the failed detection case processing unit 149 performs processing for a case where detection of a license plate has failed. For example, the failed detection case processing unit 149 generates control information for controlling the gate device 103 so as not to open the gate 103A (so as to close the gate 103A in a case where the gate 103A is already open). The processing control unit 143 supplies the control information to the gate device 103 via the communication unit 132.

When the processing in Step S164 ends, the control processing ends.

By executing each processing as described above, even in a case where a license plate has been successfully detected and character recognition of some or all of characters written on the license plate fails, the passage control system 100 can perform processing other than simply not opening the gate 103A, which is opening the gate 103A or the like for example, and can perform processing more appropriate to a situation.

Therefore, as compared to a conventional case, it is possible to allow the automobile 110 that is originally allowed to pass to pass, and reduction in convenience as a system can be prevented.

### 2. Second Embodiment

<Passage Control System>

Although the example in which a registered vehicle database 135 registered in advance is used in a passage control system 100 has been described above, further, a database in which information is updated sequentially may be utilized.

<Control Device>

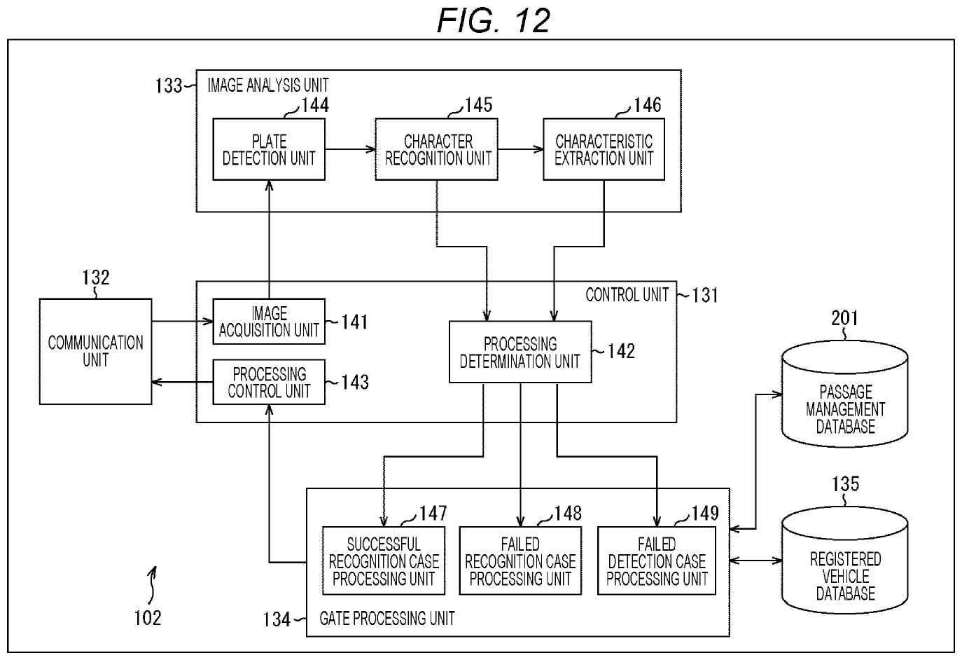

FIG. 12 is a block diagram illustrating a main configuration example of a control device 102 in that case. As illustrated in FIG. 12, the control device 102 in this case further has a passage management database 201 in addition to the configuration illustrated in FIG. 3.

The passage management database 201 is a database that registers and manages, as passage history information, information regarding any vehicle (an automobile 110) that has passed through a region where a gate device 103 controls passage, and is formed in a storage unit or the like, for example.

Similarly to a case of the registered vehicle database 135, a failed recognition case processing unit 148 refers to the passage management database 201 for a recognized vehicle registration number, a characteristic of the automobile 110, or the like.

The passage management database 201 compares the vehicle registration number, the characteristics of the vehicle, or the like referred to by the failed recognition case processing unit 148, with each registration information (passage history information), and returns a match or a mismatch. In a case of a match, registration information (passage history information) thereof is also returned.

Note that a gate processing unit 134 registers, to the passage management database 201, information regarding the vehicle (the automobile 110) that has passed through the region where the gate device 103 controls passage.

<Registration Information of Passage Management Database>

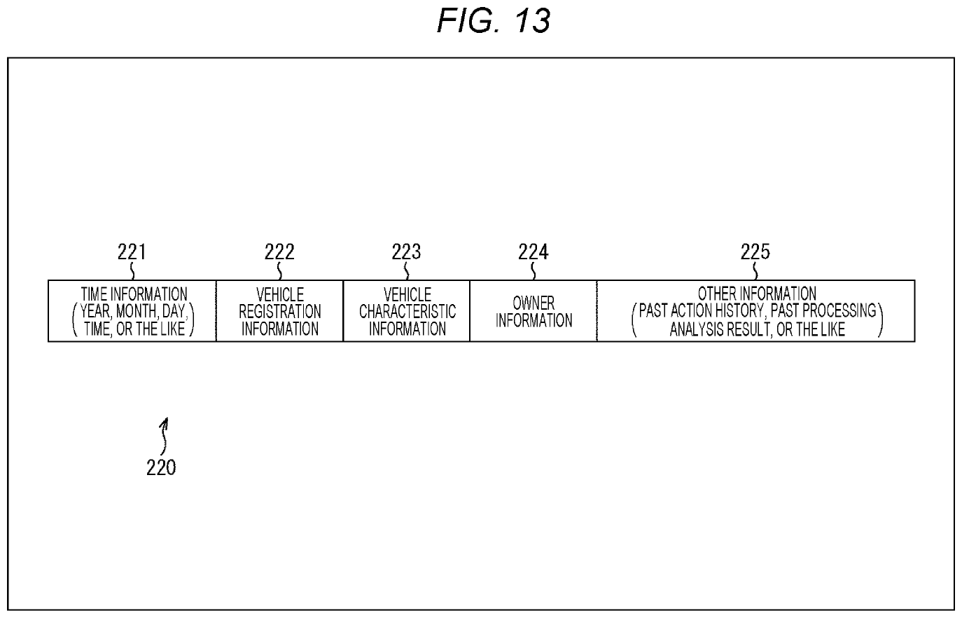

FIG. 13 illustrates an example of information registered to the passage management database 201. Registration information 220 illustrated in FIG. 13 is information regarding an arbitrary vehicle (the automobile 110) that has passed through a region where the gate device 103 controls passage. The registration information 220 may include, for example, time information 221, vehicle registration information 222, vehicle characteristic information 223, owner information 224, and other information 225.

The time information 221 is information indicating a time (For example, year, month, day, hour, minute, second, or the like) at which the registration information is registered to the passage management database 201. When the automobile 110 passes through the region where the gate device 103 controls passage, information regarding the automobile 110 is immediately registered to the passage management database 201. That is, the time information 221 is also information indicating a time when the automobile 110 passes through the region where the gate device 103 controls passage.

The vehicle registration information 222 is information similar to vehicle registration information 172. The vehicle registration information 222 is registered in a case where information of a vehicle registration number or the like of the automobile 110 that has passed through the region where the gate device 103 controls passage is obtained.

The vehicle characteristic information 223 is information similar to the vehicle characteristic information 173. The vehicle characteristic information 223 is information indicating a characteristic of the automobile 110 that has passed through the region where the gate device 103 controls passage, and is generated by the characteristic extraction unit 146 analyzing a captured image.

The owner information 224 is information similar to the owner information 171. The owner information 224 is registered in a case where information of an owner or the like of the automobile 110 that has passed through the region where the gate device 103 controls passage is obtained.

The other information 225 is other information related to the registered vehicle. For example, information such as a past action history of the vehicle or a result (for example, whether or not selected processing is appropriate, or the like) of analyzing processing performed on the vehicle in a past may be included. Furthermore, information that may be included in the other information 174 may also be included in the other information 225.

<Flow of Control Processing>

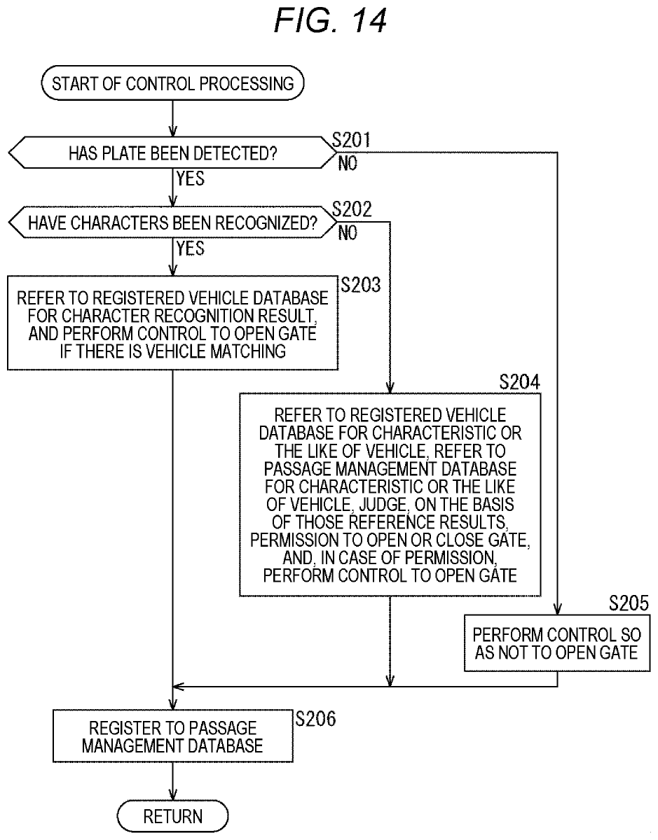

In this case also, although the passage control system 100 basically performs processing similar to the processing in a case of the first embodiment, control processing in this case is performed in the following flow, for example. An example of a flow of the control processing in this case will be described with reference to the flowchart in FIG. 14.

Each processing in Steps S201 to S203 and Step S205 are executed similarly to processing in Steps S101 to S103 and Step S165 in FIG. 11.

In Step S204, the failed recognition case processing unit 148 performs processing for a case where the license plate has been successfully detected and character recognition has been failed for some or all of the characters written on the license plate.

In this case, the failed recognition case processing unit 148 refers to the registered vehicle database 135 for the extracted characteristic of the automobile 110. Furthermore, the failed recognition case processing unit 148 refers to the passage management database 201 for the extracted characteristic of the automobile 110.

On the basis of those reference results, the failed recognition case processing unit 148 judges permission to open or close the gate. For example, in a case where passage of the automobile 110 determined, on the basis of characteristics of the vehicle, to match a registered vehicle contradicts a past passage history (for example, history of entering or exiting), the failed recognition case processing unit 148 prohibits the passage and controls the gate 103A not to open. With this arrangement, even a vehicle having a similar characteristic can be identified on the basis of the action history. Therefore, it is possible to more accurately determine whether the characteristic matches or does not match.

Note that, in a case where passage is permitted, the failed recognition case processing unit 148 generates control information for controlling the gate device 103 to open the gate 103A, similarly to the case of Step S164. The processing control unit 143 supplies the control information to the gate device 103 via the communication unit 132.

Note that, also in this case, similarly to the case of the first embodiment, the failed recognition case processing unit 148 can perform processing other than opening the gate 103A.

When the processing in Step S203 ends, the processing proceeds to Step S206. When the processing in Step S204 ends, the processing proceeds to Step S206. When the processing in Step S205 ends, the processing proceeds to Step S206.

In Step S206, the gate processing unit 134 (a successful recognition case processing unit 147, the failed recognition case processing unit 148, or a failed detection case processing unit 149) registers, to the passage management database 201, information regarding the vehicle (the automobile 110) that has passed through the region where the gate device 103 controls passage.

When the processing in Step S206 ends, the control processing ends.

As described above, by executing each processing by using the passage management database 201, the passage control system 100 can perform processing more appropriate to a situation.

### 3. Third Embodiment

<Other Configurations>

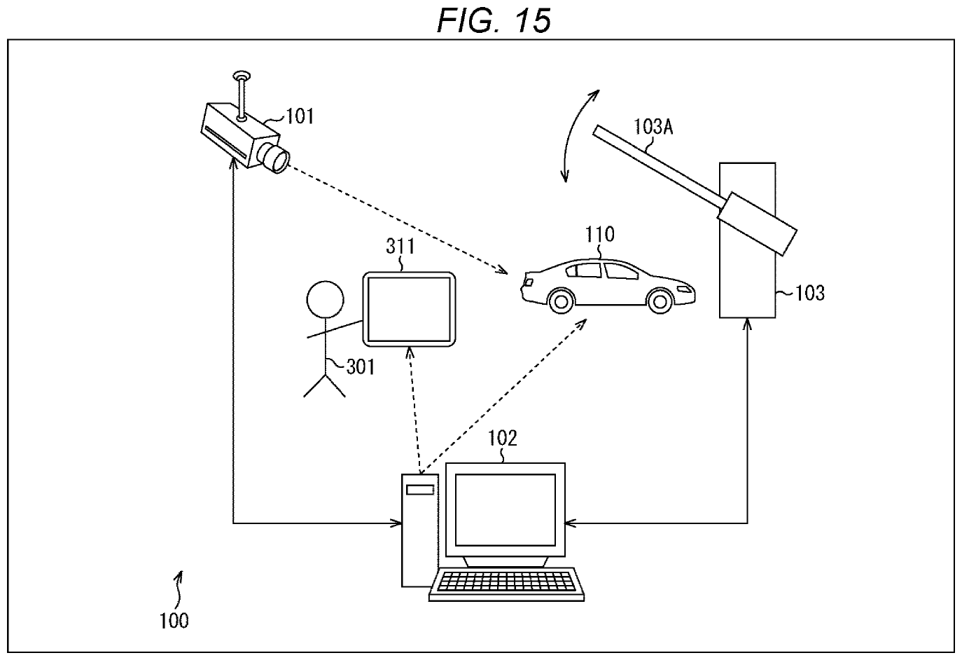

Although a gate device 103 has an output unit 184 and performs notification to an occupant of an automobile 110 in the above description, the notification may be performed by a vehicle-mounted device (for example, a terminal device of a car audio system or navigation system, or the like) of the automobile 110 as illustrated in FIG. 15, for example.

In that case, a control device 102 supplies the vehicle-mounted device with information regarding the notification, instead of supplying the information to the gate device 103, and outputs the information as an image, audio, or the like. With this arrangement, it is possible to more clearly notify the automobile 110 as a notification target.

Furthermore, as illustrated in FIG. 15, the notification may be performed in a terminal device 311 owned by an occupant 301 of the automobile 110.

In that case, the control device 102 supplies the terminal device 311 with information regarding the notification, instead of supplying the information to the gate device 103, and outputs the information as an image, audio, or the like. With this arrangement, it is possible to more clearly notify the occupant 301 as a notification target.

<Mechanical Parking Area Control System>

Although a system for controlling the gate device 103 has been described above, a control target may be other than the gate device 103. For example, a mechanical parking device having a variable parking space may be the control target.

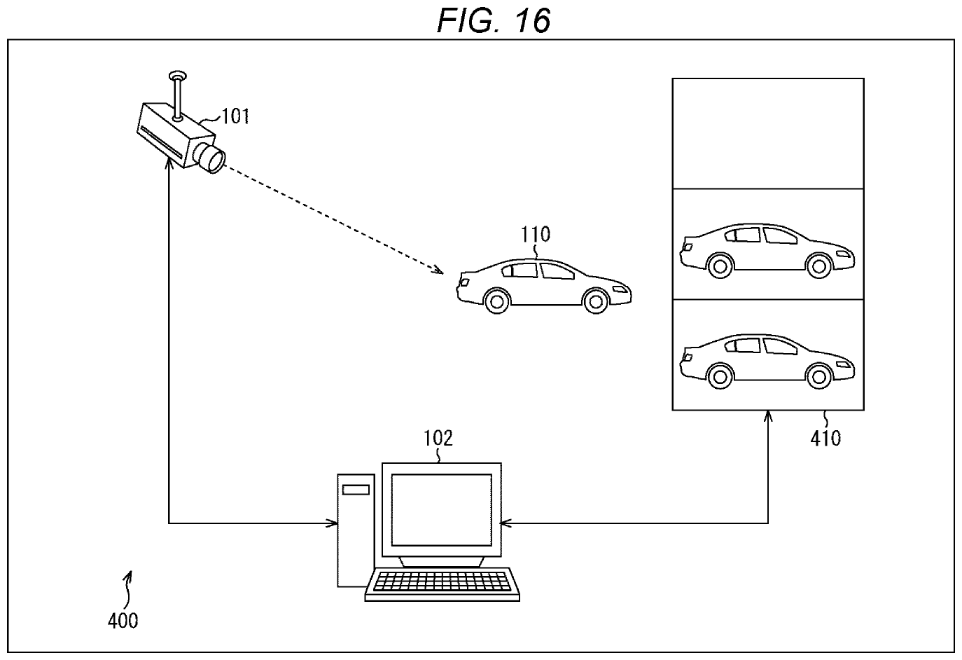

A mechanical parking area control system 400 illustrated in FIG. 16 is a system that controls a mechanical parking device 410 with a method similar to the case of the above-described passage control system 100.

That is, the control device 102 performs, on a captured image of the automobile 110 captured by an imaging device 101, an image analysis, such as license plate detection, character recognition, or characteristic extraction, and drives the mechanical parking device 410 according to the processing result.

For example, in a case where it is determined that the automobile 110 at a predetermined position is a registered vehicle in the registered vehicle database 135, the control device 102 drives the mechanical parking device 410 to a state where parking in a parking space for the automobile 110 is possible.

In such control processing, a failed recognition case processing unit 148 of the control device 102 performs processing corresponding to a case where the license plate has been successfully detected and character recognition has been failed for some or all of the characters written on the license plate. Content of this processing is similar to the case of the passage control system 100, except that the control target is the mechanical parking device 410.

With this arrangement, the mechanical parking area control system 400 can control the mechanical parking device 410 more appropriately to a situation.

<Guidance Control System>

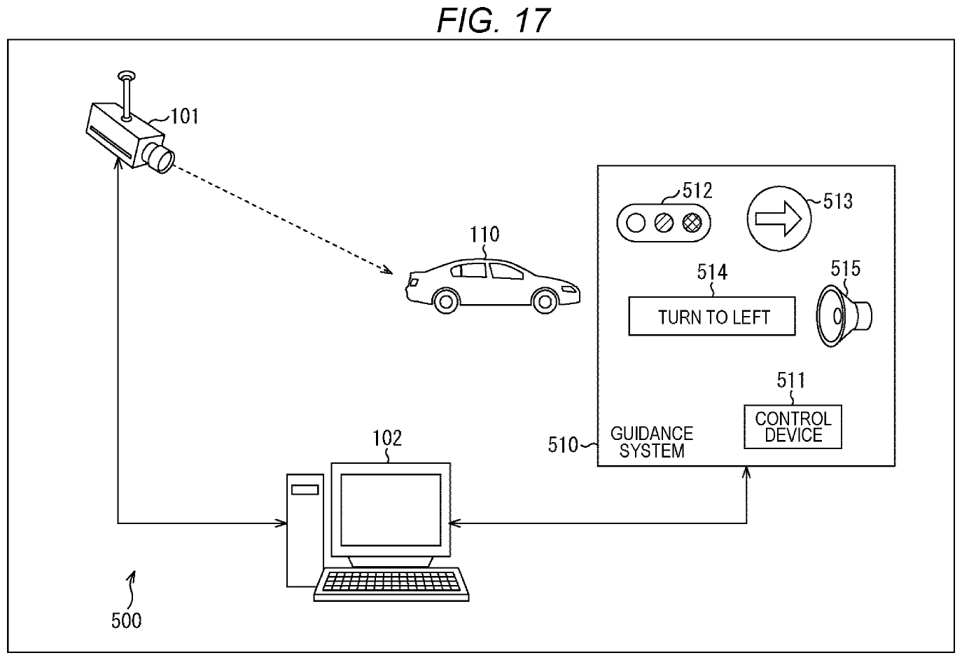

Furthermore, for example, a guidance system that guides the automobile 110 may be a control target. A guidance control system 500 illustrated in FIG. 17 is a system that controls a guidance system 510 that guides the automobile 110 with a method similar to the case of the above-described passage control system 100.

As illustrated in FIG. 15, the guidance system 510 includes, in addition to a control device 511, a controlled device such as a traffic light 512 that lights a color such as red, blue (green), or yellow according to a situation, a course display device 513 such as an arrow that displays a course, a guidance display device 514 that displays an image such as a guidance message related to the course, or an audio output device 515 such as a so-called speaker that outputs audio related to the course. These controlled devices are controlled and driven by the control device 511.

The control device 102 drives these controlled devices by controlling the control device 511 to guide the automobile 110 to a desired place. The control device 102 performs such control similarly to the case of the passage control system 100.

For example, the failed recognition case processing unit 148 of the control device 102 performs processing corresponding to a case where the license plate has been successfully detected and character recognition has been failed for some or all of the characters written on the license plate. Content of this processing is similar to the case of the passage control system 100, except that the control target is the guidance system 510.

With this arrangement, the guidance control system 500 can control the guidance system 510 more appropriately to a situation.

<Notification Control System>

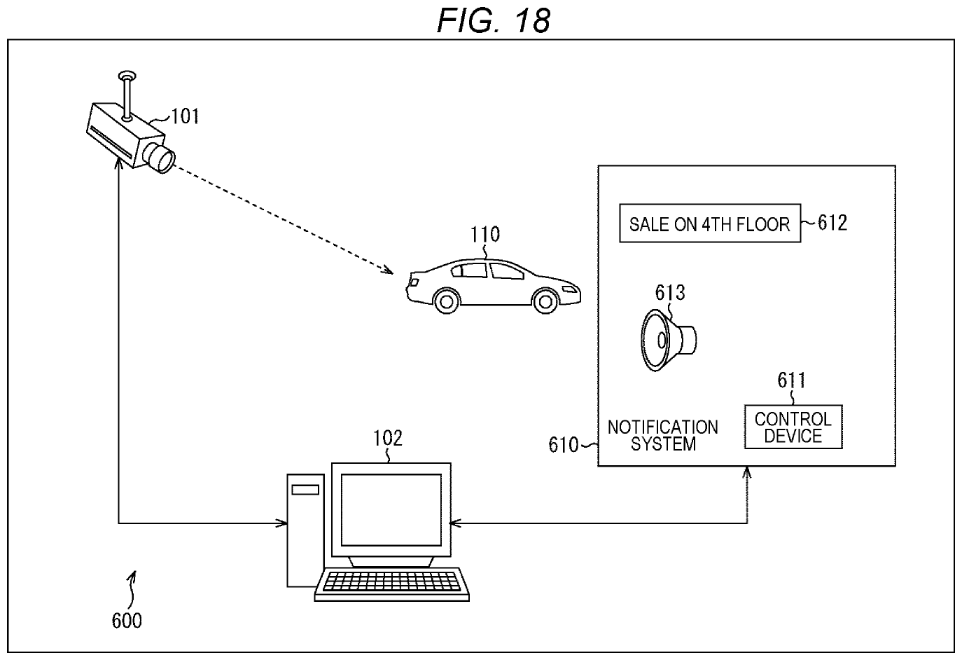

Furthermore, for example, a notification system that performs notification to the occupant of the automobile 110 may be the control target. A notification control system 600 illustrated in FIG. 18 is a system that controls a notification system 610 that performs notification to the occupant of the automobile 110 with a method similar to the case of the above-described passage control system 100.

The notification system 610 is a system that performs notification to the occupant of the automobile 110 of arbitrary information such as, for example, information of a product or an event. As illustrated in FIG. 18, in addition to the control device 611, the notification system 610 includes a controlled device such as a display device 612 that displays an image of a message or the like, or an audio output device 613 such as a so-called speaker that outputs audio related to the notification. These controlled devices are controlled and driven by the control device 611.

The control device 102 drives these controlled devices by controlling the control device 611 to notify the occupant of the automobile 110. The control device 102 performs such control similarly to the case of the passage control system 100.

For example, the failed recognition case processing unit 148 of the control device 102 performs processing corresponding to a case where the license plate has been successfully detected and character recognition has been failed for some or all of the characters written on the license plate. Content of this processing is similar to the case of the passage control system 100, except that the control target is the notification system 610.

With this arrangement, the notification control system 600 can control the notification system 610 more appropriately to a situation.

Needless to say, the control target of the control device 102 is arbitrary and is not limited to the above examples.

<4. Supplementary Note>

<Computer>

The above-described series of processing can be executed by hardware or can be executed by software. In a case where a series of processing is executed by software, a program included in the software is installed on a computer. Here, examples of the computer include a computer incorporated in dedicated hardware, a general-purpose personal computer, for example, which is capable of executing various kinds of functions by installing various kinds of programs, or the like.

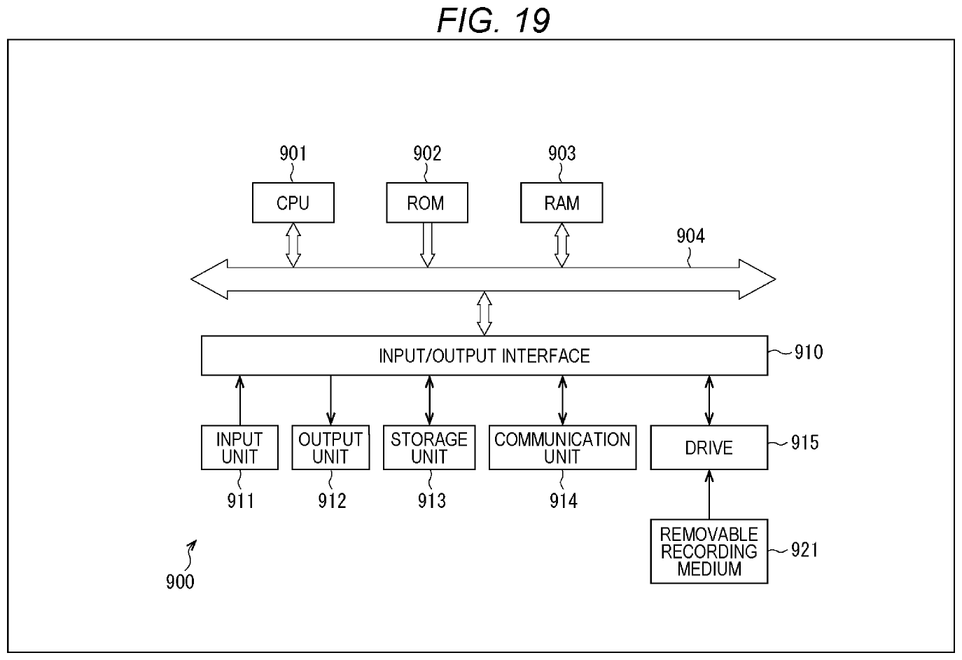

FIG. 19 is a block diagram illustrating a configuration example of hardware of a computer that executes the above-described series of processing with a program.

In a computer 900 illustrated in FIG. 19, a central processing unit (CPU) 901, a read only memory (ROM) 902, and a random access memory (RAM) 903 are mutually connected via a bus 904.

Furthermore, an input/output interface 910 is connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, or the like. The output unit 912 includes, for example, a display, a speaker, an output terminal, or the like. The storage unit 913 includes, for example, a hard disk, a RAM disk, a non-volatile memory, or the like. The communication unit 914 includes, for example, a network interface. The drive 915 drives a removable recording medium 921 such as a magnetic disk, an optical disk, a magneto-optical disk, or a semiconductor memory.

In a computer configured as above, the series of processing described above is performed by the CPU 901 loading, for example, a program stored in the storage unit 913 to the RAM 903 via the input/output interface 910 and the bus 904 and executing the program. As appropriate, the RAM 903 also stores data necessary for the CPU 901 to execute various kinds of processing.

A program executed by the computer can be applied by being recorded on the removable recording medium 921 as a package medium, or the like, for example. In this case, the program can be installed on the storage unit 913 via the input/output interface 910 by attaching the removable recording medium 921 to the drive 915.

Furthermore, the program can also be provided via a wired or wireless transmission medium such as a local area network, the Internet, or digital satellite broadcasting. In this case, the program can be received by the communication unit 914 and installed on the storage unit 913.

In addition, the program can be installed on the ROM 902 or the storage unit 913 in advance.

<Object to which Present Technology is Applied>

Furthermore, the present technology can be applied to any configuration. For example, the present technology can also be implemented as a partial configuration of a device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) obtained by further adding another function to the unit.

Furthermore, for example, the present technology can also be applied to a network system including a plurality of devices. For example, the present technology may be implemented as cloud computing in which the present technology is shared and processed jointly by a plurality of devices via a network. For example, the present technology may be implemented in cloud service that provides a service related to an image (moving image) to an arbitrary terminal such as a computer, an audio visual (AV) apparatus, a portable information processing terminal, or Internet of Things (IoT) device.

Note that, in the present description, the system means a set of a plurality of components (devices, modules (parts), or the like) without regard to whether or not all the components are in the same housing. Therefore, a plurality of devices housed in separate housings and connected via a network, and one device storing a plurality of modules in one housing are both systems.

<Others>

Embodiments of the present technology are not limited to the above-described embodiments, and various changes can be made without departing from the scope of the present technology.

For example, a configuration described as one device (or processing unit) may be divided and configured as a plurality of devices (or processing units). To the contrary, the configurations described above as a plurality of devices (or processing units) may be collectively configured as one device (or processing unit). Furthermore, needless to say, a configuration other than the configurations described above may be added to a configuration of each device (or each processing unit). Moreover, if a configuration and operation of an entire system are substantially the same, a part of a configuration of a certain device (or processing unit) may be included in a configuration of another device (or another processing unit).

Furthermore, for example, the above-described programs may be executed in an arbitrary device. In that case, the device is only required to have a necessary function (function block, or the like) so that necessary information can be acquired.

For example, in the passage control system 100 (FIGS. 1 and 15), the imaging device 101 may include some or all of functions included in the control device 102. For example, the imaging device 101 may include some or all of functions included in the image analysis unit 133.

For example, the imaging device 101 may perform, on a captured image, license plate detection. Then, in a case where the imaging device 101 can detect the license plate, a partial region including the detected license plate may be cut out of the captured image, and an image of the cut partial region may be transmitted to the control device 102.

In that case, the control unit 121 of the imaging device 101 includes the plate detection unit 144. Similarly to a case of the example in FIG. 3 or the like, the plate detection unit 144 performs license plate detection on the captured image.

In a case where the license plate can be detected (the license plate has been successfully detected), the plate detection unit 144 cuts a partial region including the detected license plate out of the captured image, supplies the communication unit 123 with an image of the cut out partial region, and causes the communication unit 123 to transmit the image to the control device 102. The communication unit 123 transmits the image of the partial region supplied from the plate detection unit 144 to the control device 102.

The communication unit 132 of the control device 102 receives the image of the partial region supplied from the imaging device 101. The image acquisition unit 141 acquires the image of the partial region received by the communication unit 132. The image acquisition unit 141 supplies the image of the partial region to the character recognition unit 145. The character recognition unit 145 performs character recognition on characters written on the license plate included in the supplied image of the partial region. In a case where the recognition of the characters written on the license plate is sufficient (the characters have been successfully recognized), the processing determination unit 142 causes the successful recognition case processing unit 147 to execute processing using the character recognition result (a vehicle registration number or the like).

Furthermore, in the above-described character recognition, in a case where the recognition of the characters written on the license plate is insufficient (the character recognition has failed), the control unit 121 of the imaging device 101 supplies the captured image (the image including the vehicle) to the communication unit 123, and causes the communication unit 123 to transmit the captured image to the control device 102. The communication unit 123 transmits the captured image to the control device 102. The communication unit 132 of the control device 102 receives the captured image supplied from the imaging device 101. The image acquisition unit 141 acquires the captured image received by the communication unit 132. The image acquisition unit 141 supplies the captured image to a characteristic extraction unit 146. The characteristic extraction unit 146 extracts characteristic information of a vehicle included in the captured image. The processing determination unit 142 causes the failed recognition case processing unit 148 to execute processing using the characteristic information.

Furthermore, in a case where the license plate cannot be detected (license plate detection has failed) in the license plate detection described above, the plate detection unit 144 supplies the communication unit 123 with control information indicating the failure, and causes the communication unit 123 to transmit the information to the control device 102. The communication unit 123 transmits the control information to the control device 102. The communication unit 132 of the control device 102 receives the control information supplied from the imaging device 101. The processing determination unit 142 acquires the control information from the communication unit 132. The processing determination unit 142 causes the failed detection case processing unit 149 to execute processing on the basis of the acquired control information.

With this arrangement, the imaging device 101 can perform the license plate detection processing.

Furthermore, for example, the imaging device 101 may perform, on the generated captured image, license plate detection and character recognition.

In that case, the control unit 121 of the imaging device 101 includes the plate detection unit 144 and the character recognition unit 145. Similarly to a case of the example in FIG. 3 or the like, the plate detection unit 144 performs license plate detection on the captured image. Similarly to a case of the example in FIG. 3 or the like, by using an image of a partial region including the license plate, the character recognition unit 145 recognizes the characters written on the license plate.

In a case where the license plate can be detected (the license plate has been successfully detected) and the characters written on the license plate are sufficiently recognized (the characters have been successfully recognized), the character recognition unit 145 supplies the communication unit 123 with text information indicating the result (for example, a recognized vehicle registration number, or the like). The communication unit 123 transmits the text information to the control device 102. The communication unit 132 of the control device 102 receives the text information. The processing determination unit 142 acquires the text information from the communication unit 132. The processing determination unit 142 causes the successful recognition case processing unit 147 to execute processing using the text information (a vehicle registration number or the like).

Furthermore, in a case where the license plate can be detected (the license plate has been successfully detected) and the recognition of the characters written on the license plate is insufficient (the character recognition has failed), the control unit 121 supplies the captured image (the image including the vehicle) to the communication unit 123, and causes the communication unit 123 to transmit the captured image to the control device 102. The communication unit 123 transmits the captured image to the control device 102. The communication unit 132 of the control device 102 receives the captured image transmitted from the imaging device 101. The image acquisition unit 141 acquires the captured image received by the communication unit 132. The image acquisition unit 141 supplies the captured image to the characteristic extraction unit 146. The characteristic extraction unit 146 extracts characteristic information of a vehicle included in the captured image. The processing determination unit 142 causes the failed recognition case processing unit 148 to execute processing using the characteristic information.

Note that, in this case, the character recognition may be performed again in the control device 102. For example, the plate detection unit 144 cuts a partial region including the detected license plate out of the captured image, supplies the communication unit 123 with an image of the cut out partial region, and causes the communication unit 123 to transmit the image to the control device 102. The communication unit 123 transmits the image of the partial region supplied from the plate detection unit 144 to the control device 102. The communication unit 132 of the control device 102 receives the image of the partial region. The image acquisition unit 141 acquires the image of the partial region from the communication unit 132, and supplies the image to the character recognition unit 145. The character recognition unit 145 performs character recognition on characters written on the license plate included in the supplied image of the partial region. In a case where the recognition of the characters written on the license plate is sufficient (the characters have been successfully recognized), the processing determination unit 142 causes the successful recognition case processing unit 147 to execute processing using the character recognition result (a vehicle registration number or the like).

Furthermore, in the above-described character recognition, in a case where the recognition of the characters written on the license plate is insufficient (the character recognition has failed), the control unit 121 of the imaging device 101 supplies the captured image (the image including the vehicle) to the communication unit 123, and causes the communication unit 123 to transmit the captured image to the control device 102. The communication unit 123 transmits the captured image to the control device 102. The communication unit 132 of the control device 102 receives the captured image supplied from the imaging device 101. The image acquisition unit 141 acquires the captured image received by the communication unit 132. The image acquisition unit 141 supplies the captured image to the characteristic extraction unit 146. The characteristic extraction unit 146 extracts characteristic information of a vehicle included in the captured image. The processing determination unit 142 causes the failed recognition case processing unit 148 to execute processing using the characteristic information.

Furthermore, in a case where the license plate cannot be detected (license plate detection has failed) in the license plate detection described above, the plate detection unit 144 supplies the communication unit 123 with control information indicating the failure, and causes the communication unit 123 to transmit the information to the control device 102. The communication unit 123 transmits the control information to the control device 102. The communication unit 132 of the control device 102 receives the control information transmitted from the imaging device 101. The processing determination unit 142 acquires the control information from the communication unit 132. The processing determination unit 142 causes the failed detection case processing unit 149 to execute processing on the basis of the acquired control information.

With this arrangement, the imaging device 101 can perform the license plate detection processing and the recognition of the characters written on the license plate.

Moreover, for example, the imaging device 101 may perform, on the generated captured image, license plate detection, character recognition, and characteristic extraction. In that case, the control unit 121 of the imaging device 101 includes the image analysis unit 133 (the plate detection unit 144, the character recognition unit 145, and the characteristic extraction unit 146).

Similarly to a case of the example in FIG. 3 or the like, the plate detection unit 144 performs license plate detection on the captured image. Similarly to a case of the example in FIG. 3 or the like, by using an image of a partial region including the license plate, the character recognition unit 145 recognizes the characters written on the license plate. Similarly to a case of the example in FIG. 3 or the like, the characteristic extraction unit 146 extracts a characteristic of the vehicle from the captured image.

For example, in a case where the license plate has been detected and the characters written on the license plate are sufficiently recognized (the characters have been successfully recognized), the communication unit 123 of the imaging device 101 transmits text information indicating the result (for example, a recognized vehicle registration number, or the like) to the control device 102. The processing determination unit 142 of the control device 102 causes the successful recognition case processing unit 147 to execute processing using the text information (the vehicle registration number or the like).

Furthermore, in a case where the license plate can be detected (the license plate has been successfully detected) and the recognition of the characters written on the license plate is insufficient (the character recognition has failed), the characteristic extraction unit 146 extracts, from the captured image, characteristic information of the vehicle. The characteristic extraction unit 146 supplies the characteristic information to the communication unit 123 and causes the communication unit 123 to transmit the characteristic information to the imaging device 101. The communication unit 123 transmits the characteristic information to the imaging device. The communication unit 132 of the control device 102 receives the characteristic information transmitted from the imaging device 101. The processing determination unit 142 causes the failed recognition case processing unit 148 to execute processing using the characteristic information.

Furthermore, in a case where the license plate cannot be detected (license plate detection has failed) in the license plate detection described above, the plate detection unit 144 supplies the communication unit 123 with control information indicating the failure, and causes the communication unit 123 to transmit the information to the control device 102. The communication unit 123 transmits the control information to the control device 102. The communication unit 132 of the control device 102 receives the control information transmitted from the imaging device 101. The processing determination unit 142 acquires the control information from the communication unit 132. The processing determination unit 142 causes the failed detection case processing unit 149 to execute processing on the basis of the acquired control information.

With this arrangement, the imaging device 101 can perform the license plate detection processing, the recognition of the characters written on the license plate, and extraction of the characteristic information of the vehicle.

Furthermore, for example, each step in one flowchart may be executed by one device, or may be executed by being shared by a plurality of devices. Moreover, in a case where a plurality of pieces of processing is included in one step, the plurality of pieces of processing may be executed by one device, or may be executed by being shared by a plurality of devices. In other words, a plurality of pieces of processing included in one step can be executed as processing of a plurality of steps. To the contrary, pieces of processing described as a plurality of steps can be collectively executed as one step.

Furthermore, for example, a program executed by the computer may be a program in which processing of steps describing the program is executed in time series in an order described in the present description, or a program in which the processing may be executed in parallel, or separately at a necessary timing such as when a call is made. That is, unless there is a contradiction, the processing of each step may be executed in an order different from the order described above. Moreover, the processing of steps describing the program may be executed in parallel with processing of another program, or may be executed in combination with processing of another program.

Furthermore, for example, a plurality of techniques related to the present technology can be implemented independently as a single piece unless there is a contradiction. Needless to say, a plurality of arbitrary pieces of the present technology can be used in combination. For example, a part or all of the present technology described in any of the embodiments can be implemented in combination with a part or all of the present technology described in another embodiment. Furthermore, any part or all of the present technology described above can be implemented in combination with another technology not described above.

Note that the present technology can have the following configurations.

(1) An information processing device including

a characteristic extraction unit that extracts, from a captured image, on the basis of a recognition result with respect to a license plate of a vehicle in the captured image, characteristic information of the vehicle, and

a processing execution unit that performs processing corresponding to the characteristic information of the vehicle, the characteristic information being extracted by the characteristic extraction unit.

(2) The information processing device according to (1),

in which, in a case where at least a part of a vehicle registration number on the license plate cannot be recognized as the recognition result, the characteristic extraction unit extracts the characteristic information from the captured image.

(3) The information processing device according to (1),

in which the characteristic extraction unit identifies, as the characteristic information, at least any one of a vehicle name, vehicle type, model, and vehicle color of the vehicle.

(4) The information processing device according to (1),

in which the processing execution unit refers, for the characteristic information, to a registered vehicle database in which a characteristic of a registered vehicle is registered in advance, and performs processing corresponding to a reference result.

(5) The information processing device according to (4),

in which qualification information of the registered vehicle is registered in the registered vehicle database, and

the processing execution unit performs processing corresponding to the qualification information of the registered vehicle based on the characteristic information.

(6) The information processing device according to (1),

in which the processing execution unit refers, for the characteristic information, to a passage management database that manages passage history information related to a vehicle that has passed a predetermined place, and performs processing corresponding to a reference result.

(7) The information processing device according to (1),

in which, according to the characteristic information, the processing execution unit performs processing related to control of opening/closing of a gate.

(8) The information processing device according to (7),

in which, according to the characteristic information, the processing execution unit further controls execution of payment processing.

(9) The information processing device according to (7),

in which, according to the characteristic information, the processing execution unit further controls a setting for a payment method.

(10) The information processing device according to (7), further including

a gate opening/closing unit that opens and closes the gate,

in which the processing execution unit controls the gate opening/closing unit according to the characteristic information.

(11) The information processing device according to (1),

in which, according to the characteristic information, the processing execution unit performs processing related to control of a mechanical parking device.

(12) The information processing device according to (1),

in which, according to the characteristic information, the processing execution unit performs processing related to control of a guidance system that guides a vehicle.

(13) The information processing device according to (1),

in which, according to the characteristic information, the processing execution unit performs processing related to control of a notification system that performs notification to an occupant of a vehicle.

(14) The information processing device according to (1), further including

a character recognition unit that recognizes a character written on a license plate of the vehicle.

(15) The information processing device according to (1), further including

a plate detection unit that performs detection of the license plate from the captured image.

(16) The information processing device according to (15), further including

a character recognition unit that recognizes, in a case where the license plate is detected from the captured image, a character written on the license plate.

(17) The information processing device according to (1), further including

an imaging unit that captures an image of a vehicle and generates the captured image.

(18) The information processing device according to (1), further including

a communication unit that performs communication,

in which, according to the characteristic information, the processing execution unit performs, via the communication unit, processing related to control of another device.

(19) An information processing method including

extracting, from a captured image, on the basis of a recognition result with respect to a license plate of a vehicle in the captured image, characteristic information of the vehicle, and

performing processing corresponding to the extracted characteristic information of the vehicle.

(20) A program that causes a computer to function as

a characteristic extraction unit that extracts, from a captured image, on the basis of a recognition result with respect to a license plate of a vehicle in the captured image, characteristic information of the vehicle, and

a processing execution unit that performs processing corresponding to the characteristic information of the vehicle, the characteristic information being extracted by the characteristic extraction unit.

### REFERENCE SIGNS LIST

100 Passage control system
101 Imaging device
102 Control device
103 Gate device
110 Automobile
121 Control unit
122 Imaging unit
123 Communication unit
124 Drive unit
131 Control unit
132 Communication unit
133 Image analysis unit
134 Gate processing unit
135 Registered vehicle database
141 Image acquisition unit
142 Processing determination unit
143 Processing control unit
144 Plate detection unit
145 Character recognition unit
146 Characteristic extraction unit
147 Successful recognition case processing unit
148 Failed recognition case processing unit
149 Failed detection case processing unit
170 Registration information
171 Owner information
172 Vehicle registration information
173 Vehicle characteristic information
174 Other information
181 Control unit
182 Communication unit
183 Gate opening/closing unit
184 Output unit
201 Passage management database
220 Registration information
221 Time information
222 Vehicle registration information
223 Vehicle characteristic information
224 Owner information
225 Other information
301 Occupant
311 Terminal device
400 Mechanical parking area control system
410 Mechanical parking device
500 Guidance control system
510 Guidance system
511 Control device
512 Traffic light
513 Course display device
514 Guidance display device
515 Audio output device
600 Notification control system
610 Notification system
611 Control device
612 Display device
613 Audio output device

1. An information processing device comprising:
a characteristic extraction unit that extracts, from a captured image, on a basis of a recognition result with respect to a license plate of a vehicle in the captured image, characteristic information of the vehicle; and
a processing execution unit that performs processing corresponding to the characteristic information of the vehicle, the characteristic information being extracted by the characteristic extraction unit.

2. The information processing device according to claim 1,
wherein, in a case where at least a part of a vehicle registration number on the license plate cannot be recognized as the recognition result, the characteristic extraction unit extracts the characteristic information from the captured image.

3. The information processing device according to claim 1,
wherein the characteristic extraction unit identifies, as the characteristic information, at least any one of a vehicle name, vehicle type, model, and vehicle color of the vehicle.

4. The information processing device according to claim 1,
wherein the processing execution unit refers, for the characteristic information, to a registered vehicle database in which a characteristic of a registered vehicle is registered in advance, and performs processing corresponding to a reference result.

5. The information processing device according to claim 4,
wherein qualification information of the registered vehicle is registered in the registered vehicle database, and
the processing execution unit performs processing corresponding to the qualification information of the registered vehicle based on the characteristic information.

6. The information processing device according to claim 1,
wherein the processing execution unit refers, for the characteristic information, to a passage management database that manages passage history information related to a vehicle that has passed a predetermined place, and performs processing corresponding to a reference result.

7. The information processing device according to claim 1,
wherein, according to the characteristic information, the processing execution unit performs processing related to control of opening/closing of a gate.

8. The information processing device according to claim 7,
wherein, according to the characteristic information, the processing execution unit further controls execution of payment processing.

9. The information processing device according to claim 7,
wherein, according to the characteristic information, the processing execution unit further controls a setting for a payment method.

10. The information processing device according to claim 7, further comprising
a gate opening/closing unit that opens and closes the gate,
wherein the processing execution unit controls the gate opening/closing unit according to the characteristic information.

11. The information processing device according to claim 1,
wherein, according to the characteristic information, the processing execution unit performs processing related to control of a mechanical parking device.

12. The information processing device according to claim 1,
wherein, according to the characteristic information, the processing execution unit performs processing related to control of a guidance system that guides a vehicle.

13. The information processing device according to claim 1,
wherein, according to the characteristic information, the processing execution unit performs processing related to control of a notification system that performs notification to an occupant of a vehicle.

14. The information processing device according to claim 1, further comprising
a character recognition unit that recognizes a character written on a license plate of the vehicle.

15. The information processing device according to claim 1, further comprising
a plate detection unit that performs detection of the license plate from the captured image.

16. The information processing device according to claim 15, further comprising
a character recognition unit that recognizes, in a case where the license plate is detected from the captured image, a character written on the license plate.

17. The information processing device according to claim 1, further comprising
an imaging unit that captures an image of a vehicle and generates the captured image.

18. The information processing device according to claim 1, further comprising
a communication unit that performs communication,
wherein, according to the characteristic information, the processing execution unit performs, via the communication unit, processing related to control of another device.

19. An information processing method comprising:
extracting, from the captured image, on a basis of a recognition result with respect to a license plate of a vehicle in a captured image, characteristic information of the vehicle; and
performing processing corresponding to the extracted characteristic information of the vehicle.

20. A program that causes a computer to function as:
a characteristic extraction unit that extracts, from a captured image, on a basis of a recognition result with respect to a license plate of a vehicle in the captured image, characteristic information of the vehicle; and
a processing execution unit that performs processing corresponding to the characteristic information of the vehicle, the characteristic information being extracted by the characteristic extraction unit.
